(19) United States
(12) Patent Application Publication
(10) Pub. No.: US 2023/0199560 A1
(43) Pub. Date: Jun. 22, 2023

(54) Energy-Aware Traffic Management for Multi-Access Data Sessions

(71) Applicant: Google LLC, Mountain View, CA (US)

(72) Inventors: Pavan Santhana Krishna Nuggehalli, San Carlos, CA (US); Jibing Wang, San Jose, CA (US); Ning Zhang, Saratoga, CA (US); Mingguang Xu, San Jose, CA (US); Kai Shi, San Jose, CA (US)

(73) Assignee: Google LLC, Mountain View, CA (US)

(21) Appl. No.: 17/999,175

(22) PCT Filed: May 14, 2021
(86) PCT No.: PCT/US2021/032440

§ 371 Date: Nov. 17, 2022

Related U.S. Application Data
(60) Provisional application No. 63/026,644, filed on May 18, 2020.

(51) Int. Cl. H04W 28/08; H04W 24/10; H04W 74/00; H04W 72/23

(52) U.S. Cl. CPC H04W 28/0917; H04W 24/10; H04W 74/006; H04W 72/23

(57) ABSTRACT

This document describes improvements in management of data traffic of user equipment between cellular and non-cellular accesses in fifth generation new radio, 5G NR, wireless networks. An energy-aware traffic manager is introduced to manage data traffic communicated by the user equipment over the cellular access and the non-cellular access, such as a wireless local area network, WLAN. The energy-aware traffic manager enables reporting of energy-related information by user equipment, energy-aware traffic management modes for the user equipment, and access management in response to critical events related to user equipment energy, as well as reporting of changes in the user equipment access management or access management modality to core network entities. By so doing, the energy-aware traffic manager enables data traffic management based on aspects of user equipment energy, which may reduce user equipment energy consumption associated with communicating data over multiple accesses and extend battery life of the user equipment.

### BACKGROUND

The evolution of wireless communication to fifth generation (5G) standards and technologies provides higher data rates and greater capacity with improved reliability and lower latency that enhances mobile broadband services. 5G technologies also provide new classes of service for vehicular networking, fixed wireless broadband, and the Internet of Things (IoT).

For various service data flows, cellular access networks of a 5G wireless system provide higher data rates than conventional cellular networks. It may also be desirable to use non-cellular access networks, such as Wireless Local Area Network (WLAN) networks, alongside the cellular access networks of the 5G wireless system. For example, some data traffic may be routed through a non-cellular access network to reduce traffic congestion on a cellular network and/or ensure cellular network capacity is available for data transmissions of other end users of the wireless system (e.g., for which non-cellular access is unavailable).

Conventional techniques for routing data traffic between cellular access networks and non-cellular access networks, however, are implemented using network-centric policies that are provisioned across large numbers of user equipment. Because the network-centric policies generally fail to regard the operating conditions of the user equipment when selecting an access network to route the data traffic, the user equipment may be configured by the network to use an access network with an excessive level of power consumption or increased thermal profile relative to other available network access options. As such, routing the data traffic using the network-centric policies may shorten user equipment runtime or further contribute to user equipment overheating, resulting in poor end user experience.

### SUMMARY

This summary is provided to introduce simplified concepts of energy-aware traffic management for multi-access data sessions. The simplified concepts are further described below in the Detailed Description. This summary is not intended to identify essential features of the claimed subject matter nor is it intended for use in determining the scope of the claimed subject matter.

This disclosure describes improvements in management of data traffic of user equipment between cellular and non-cellular accesses in fifth generation new radio (5G NR) wireless networks. An energy-aware traffic manager is introduced to manage data traffic communicated by the user equipment over the cellular access and the non-cellular access, such as a Wireless Local Area Network (WLAN). The energy-aware traffic manager enables reporting of energy-related information by user equipment, energy-aware traffic management modes for the user equipment, and access management in response to critical events related to user equipment energy. The energy-aware traffic manager can also report changes in the user equipment access management or access management modality to core network entities, such as a user plane function of the 5G NR wireless network. By so doing, the energy-aware traffic manager enables data traffic management based on aspects of user equipment energy or other local conditions, which may reduce user equipment energy consumption associated with communicating data over one or more different access types and extend battery life of the user equipment.

In some aspects, a method of managing data traffic of a user equipment between a cellular access and a non-cellular access of a wireless network is described in which the user equipment determines a first level of energy consumption associated with an uplink of the cellular access provided via a base station of the wireless network. The user equipment also determines a second level of energy consumption associated with an uplink of the non-cellular access provided by a wireless local area network access point of the wireless network. The cellular access and non-cellular access are anchored by a user plane function (UPF) of the wireless network. Based on the first level of energy consumption and the second level of energy consumption, the user equipment selects, as an uplink access, one of the uplink of the cellular access or the uplink of the non-cellular access for transferring data traffic to the wireless network. The user equipment then transfers the data traffic of the user equipment via the selected uplink access to the UPF.

In other aspects, a method of managing data traffic of a user equipment between a cellular access and a non-cellular access of a wireless network includes detecting, at the user equipment, a critical event related to user equipment energy. In response to detecting the critical event, the user equipment estimates respective levels of energy consumption for the user equipment to transmit, via an uplink of the cellular access and an uplink of the non-cellular access, the data traffic to the wireless network. The cellular access and non-cellular access are anchored by a UPF of the wireless network. The user equipment then selects, based on the respective levels of energy consumption, the uplink of the cellular access or the uplink of the non-cellular access as an uplink access to transfer the data traffic of the user equipment to the wireless network. The user equipment then transfers the data traffic of the user equipment via the selected uplink access to the UPF of the wireless network.

In further aspects, a method of selecting between a cellular-access and a non-cellular access of a wireless network for a downlink to a user equipment includes sending, by a UPF of the wireless network, a measurement report request to the user equipment via a performance measurement function (PMF) protocol. The UPF receives, via the PMF protocol, a measurement report from the user equipment that includes respective energy-related information for the cellular access or the non-cellular access. Based on the respective energy-related information, the UPF selects one of a downlink of the cellular access or a downlink of the non-cellular access as a selected downlink access for transferring data traffic to the user equipment. The UPF then transfers the data traffic via the selected downlink access to the user equipment.

### BRIEF DESCRIPTION OF THE DRAWINGS

Aspects of energy-aware traffic management for multi-access data sessions are described with reference to the following drawings. The same numbers are used throughout the drawings to reference like features and components:

FIG. 1 illustrates an example wireless network environment in which various aspects of energy-aware traffic management for multi-access data sessions can be implemented.

FIG. 2 illustrates an example environment as generally relating to cellular and non-cellular access networks that can implement various aspects of energy-aware traffic management for multi-access data sessions.

FIG. 3 illustrates an example of a multi-access data session between a user equipment and a core network implemented in accordance with one or more aspects.

FIG. 4 illustrates example configurations of the user equipment and the core network of FIG. 3, including components to implement various aspects of energy-aware traffic management for multi-access data sessions.

FIG. 5 illustrates an example device diagram for devices that can implement various aspects of energy-aware traffic management for multi-access data sessions.

FIG. 6 illustrates an example device diagram for network entities that can implement various aspects of energy-aware traffic management for multi-access data sessions.

FIG. 7A illustrates example details of data and control transactions between devices selecting an uplink access or a downlink access to steer data traffic in accordance with aspects of energy-aware traffic management.

FIG. 7B illustrates example details of data and control transactions between devices switching an uplink access or a downlink access in accordance with aspects of energy-aware traffic management.

FIG. 7C illustrates example details of data and control transactions between devices splitting data traffic in an uplink access or a downlink access in accordance with aspects of energy-aware traffic management.

FIG. 7D illustrates example details of data and control transactions between devices merging a split uplink and downlink accesses to provide a single access in accordance with aspects of energy-aware traffic management.

FIG. 8A illustrates example details of data and control transactions between devices steering data traffic over an uplink access or a downlink access in accordance with an energy-aware traffic management mode.

FIG. 8B illustrates example details of data and control transactions between devices switching an uplink access or a downlink access in accordance with an energy-aware traffic management mode.

FIG. 8C illustrates example details of data and control transactions between devices splitting data traffic in an uplink access or a downlink access in accordance with an energy-aware traffic management mode.

FIG. 8D illustrates example details of data and control transactions between devices merging split accesses to provide a single access in accordance with an energy-aware traffic management mode.

FIG. 9 illustrates example details of data and control transactions between devices for switching an uplink access or downlink access in response to a critical event related to user equipment energy in accordance with one or more aspects.

FIG. 10 illustrates an example method of energy-aware traffic management as generally related to selecting a downlink access to steer data traffic based on energy-related information provided by a user equipment.

FIG. 11 illustrates an example method of providing energy-related information of a user equipment to a user plane function of a wireless network to facilitate downlink access selection in accordance with aspects of energy-aware traffic management.

FIG. 12A illustrates an example method of energy-aware traffic management as generally related to selecting an uplink access based on respective energy consumption of cellular and non-cellular accesses of a wireless network.

FIG. 12B illustrates an example method of energy-aware traffic management as generally related to splitting data traffic in an uplink access based on respective energy consumption of cellular and non-cellular accesses of a wireless network.

FIG. 13 illustrates an example method of switching an uplink access in response to a critical event related to user equipment energy in accordance with aspects of the techniques described herein.

FIG. 14 illustrates an example method of energy-aware traffic management as generally related to overriding an active steering mode of a user equipment in accordance with aspects of the techniques described herein.

### DETAILED DESCRIPTION

This disclosure describes improvements in management of data traffic of user equipment between cellular and non-cellular accesses in fifth generation new radio (5G NR) wireless networks. An energy-aware traffic manager is introduced to manage data traffic communicated by the user equipment over the cellular access and the non-cellular access, such as a Wireless Local Area Network (WLAN). The energy-aware traffic manager enables reporting of energy-related information by user equipment, energy-aware traffic management modes for the user equipment, and access selection (e.g., for access steering or switching) in response to critical events related to user equipment battery status. The energy-aware traffic manager may also report changes in the user equipment access selection or traffic management modality to core network entities, such as a user plane function of the 5G NR wireless network. By so doing, the energy-aware traffic manager enables data traffic management, which may include traffic steering, switching, or splitting, based on aspects of user equipment battery status or thermal conditions. This may reduce user equipment energy consumption associated with communicating data over one or more different access types and extend battery life of the user equipment.

In contrast with conventional access traffic steering, switching, and splitting (ATSSS), the techniques described herein enable a user equipment to steer, switch, or split data traffic between cellular and non-cellular accesses based on respective levels of energy consumption of the accesses and/or other conditions of the user equipment. As described herein, aspects of energy-aware traffic management may include traffic steering to select a cellular access or non-cellular access over which to transfer data traffic. Alternatively or additionally, aspects of energy-aware traffic management may include traffic switching to handover data traffic between a cellular access or non-cellular access. Aspects of energy-aware traffic management also include traffic splitting to split data traffic between aggregate bandwidth of a cellular access or non-cellular access, and/or access merging that combines split accesses to provide a single access for the data traffic. For example, an energy-aware management mode as described herein may enable the user equipment to select or switch to an uplink access that consumes a lower amount of energy, thereby reducing energy consumed by a wireless transceiver of the user equipment to communicate data traffic with a wireless network and extend battery life of the user equipment. In some cases, the user equipment overrides other types of steering modes (e.g., ATSSS steering modes) to direct the data traffic to a lower energy access, such as when a battery capacity of the user equipment falls below a predefined threshold. The user equipment may be configured with an energy-aware traffic manager, an energy-aware management mode, or energy-aware rules to enable the user equipment to steer, switch, or split data traffic between cellular and non-cellular accesses based on energy-related information or other local conditions of the user equipment to reduce energy consumption of the user equipment, thereby extending user equipment runtime or mitigating effects associated with an overheating user equipment.

In aspects, energy-aware traffic management for multi-access data sessions provides new traffic management modes, steering mode enhancements, protocol messages, and rules to support energy-aware management of traffic over one or more concurrent cellular and/or non-cellular accesses. The described aspects may also enable a user equipment to manage an uplink access based on energy consumption or local conditions, as well as report energy-related information to the network to facilitate downlink access management based on the energy-related information of the user equipment.

While features and concepts of the described systems and methods of energy-aware traffic management for multi-access data sessions can be implemented in any number of different environments, systems, devices, and/or various configurations, aspects of energy-aware traffic management for multi-access data sessions are described in the context of the following example devices, systems, and configurations.

Example Environment

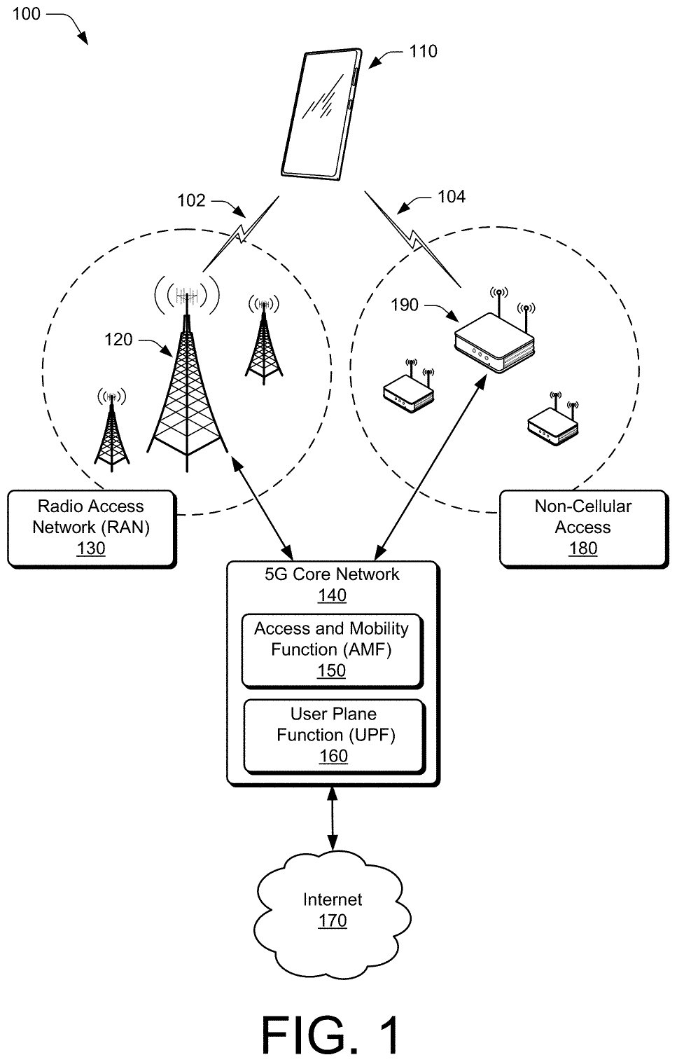

FIG. 1 illustrates an example environment 100, which includes a user equipment 110 (UE 110). The user equipment 110 can communicate with a base station 120 through a wireless communication link 102 (wireless link 102) of a cellular access (e.g., a 3GPP access). For simplicity, the user equipment 110 is implemented as a smartphone but may be implemented as any suitable computing or electronic device, such as a mobile communication device, residential gateway, modem, cellular phone, gaming device, navigation device, media device, laptop computer, desktop computer, tablet computer, smart appliance, vehicle-based communication system, or an Internet-of-Things (IoT) device such as a sensor or an actuator. The base station 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, distributed base station, or the like, or any combination or future evolution thereof.

The base station 120 communicates with the user equipment 110 using the wireless link 102, which may be implemented as any suitable type of wireless link associated with or provided through a cellular access (e.g., a 3GPP access). The wireless link 102 includes control and data communication, such as downlink of data and control information communicated from the base station 120 to the user equipment 110, uplink of other data and control information communicated from the user equipment 110 to the base station 120, or both. In aspects, the wireless link can also carry control information from a core network (e.g., a 5G core network 140) to the user equipment 110, including ATSSS rules (e.g., ATSSS rules 350) from a policy control function 270 (PCF 270) via an access and mobility function 150 (AMF 150) of the core network. The wireless link 102 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and so forth. Multiple wireless links 102 may be aggregated in a carrier aggregation or multi-connectivity technology to provide a higher data rate for the user equipment 110. Multiple wireless links 102 from multiple base stations 120 may be configured for Coordinated Multipoint (CoMP) communication with the user equipment 110.

The base station 120 and any additional base stations are collectively a Radio Access Network 130 (RAN 130, 5G NR RAN, NR RAN, Evolved Universal Terrestrial Radio Access Network 130, or E-UTRAN 130), which are connected via a fifth generation (5G) core 140 (5GC 140) network to form a wireless operator network. The 5GC includes an Access and Mobility Function 150 (AMF 150) that provides control-plane functions such as registration and authentication of multiple user equipment 110, authorization, mobility management, or the like in a cellular network. The AMF 150 communicates with the base stations 120 in the RAN 130 and also communicates with multiple user equipment 110, via the base stations 120. The 5GC 140 includes a User Plane Function 160 (UPF 160) that is a gateway to connect base stations 120 to the Internet 170. The 5GC 140 may include additional features that are omitted from FIG. 1 for the sake of clarity. The user equipment 110 may connect, via the 5GC 140, to public networks, such as the Internet 170 to interact with a remote service (not shown).

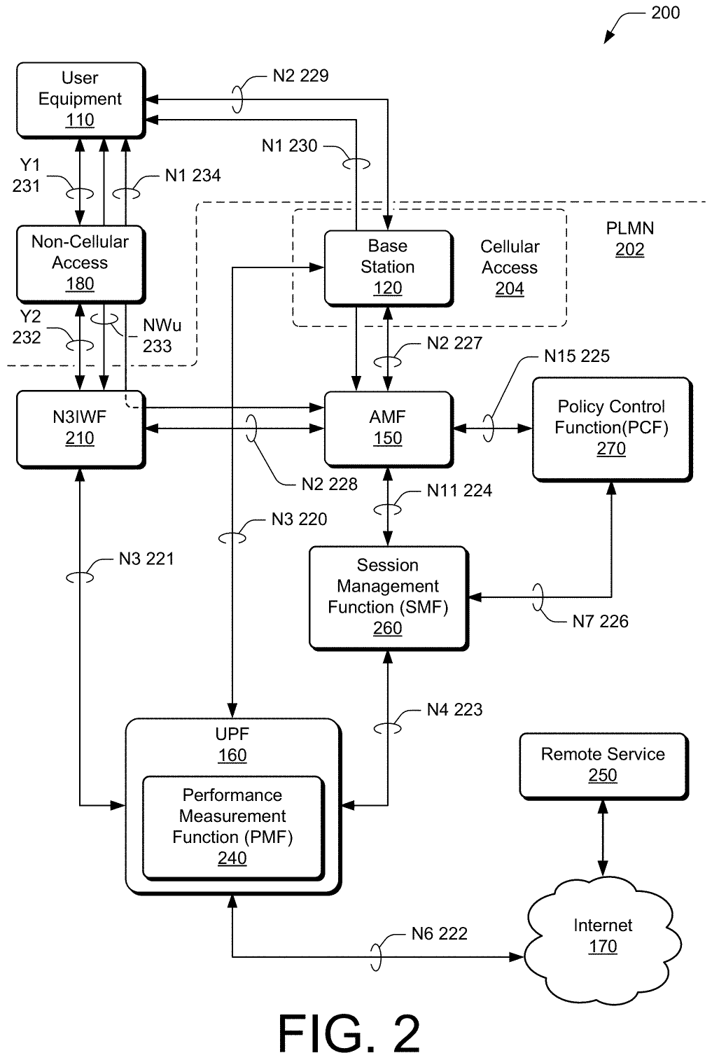

The user equipment 110 also can connect to the 5GC 140 through a non-cellular access 180 that is connected to the 5GC 140. The non-cellular access 180 may include an untrusted non-3GPP access and/or a trusted non-3GPP access. The non-cellular access 180 of the example environment 100 is illustrated as an untrusted non-3GPP access architecture in which the untrusted non-3GPP access connects to the 5GC via a non-3GPP inter-working function (N3IWF), such as the N3IWF 210 described with reference to FIG. 2. Alternatively or in addition, the illustrated architecture may include a trusted non-3GPP access that connects to the 5GC 140 via a trusted non-3GPP gateway function (TNGF), which is described below with reference to a trusted non-3GPP access network (TNAN). In this example, the user equipment 110 connects to the 5GC 140 using a wireless local area network (WLAN) connection 104 to a WLAN access point 190 that is connected to the 5GC 140. The WLAN access point 190 may be located in a user's home, an office, airport, coffee shop, and so forth. Each WLAN access point 190 may be independently operated, such as in a user's home, may be part of an enterprise network, or may be operated as part of a public network of WLAN access points operated by a wireless network operator. The WLAN wireless network operator may be the same as the operator of the RAN 130 or different than the operator of the RAN 130.

FIG. 2 illustrates an example environment 200 in which aspects of energy-aware traffic management for multi-access data sessions can be implemented. In various aspects, energy-aware traffic management modes, enhanced ATSSS steering modes, and energy-aware reporting procedures are implemented by entities of the example environment 200. In this example, a wireless operator network implements a public land mobile network 202 (PLMN 202) that includes a cellular access 204, which for the sake of visual clarity, is illustrated as a single base station 120 of a RAN 130. The example environment 200 also includes a non-cellular access 180, such as a WLAN that is accessible through one or more WLAN access points 190 (not shown). Generally, the user equipment 110 establishes and maintains one or more concurrent connections with a 5G core or other network core of the PLMN 202 through the cellular access 204 and/or the non-cellular access 180.

The 5G core of the PLMN 202 includes a user plane function (UPF), illustrated as UPF 160, which is a gateway to connect the base station 120 and the non-cellular access 180 (via a non-3GPP inter-working function 210 (N3IWF 210) if the non-cellular access 180 is untrusted) to the Internet 170. The UPF 160 also serves as an anchor or termination for protocol data unit (PDU) sessions by which the user equipment 110 communicates data over the cellular access 204 and/or the non-cellular access 180. A performance measurement function 240 (PMF 240) is implemented by the UPF 160 to measure various parameters of user equipment or network performance, such as access availability, round-trip timing, and energy-related information in accordance with one or more aspects. The base station 120 and N3IWF 210 connect to the UPF 160, respectively, via an N3 interface at 220 and 221. The UPF 160 connects to the Internet, through which a remote service 250 is accessible, via an N6 interface at 222. The UPF 160 also connects to a session management function 260 (SMF 260) of the 5G core network via an N4 interface at 223.

To complete the description of the generic network architecture, an access and mobility function 150 (AMF 150) of the 5G core network connects to the SMF 260 and a policy control function 270 (PCF 270), respectively, via an N1 1 interface and an N1 5 interface at 224 and 225. The PCF 270 connects to the SMF 260 via an N7 interface at 226 and provides data traffic management policies, including energy-aware traffic management policies and rules, to other network entities, such as the user equipment 110, the SMF 260, and UPF 160. In aspects, the PCF 270 pushes ATSSS polices that include the described energy-aware traffic management steering modes, rules, or functionalities that are enforced at the user equipment 110 with respect to uplink access and enforced at the UPF 160 with respect to downlink access. For example, the PCF 270 can push an energy-aware traffic management policy to the user equipment 110 that includes energy-aware rules that specify traffic steering functionalities and steering modes as described herein.

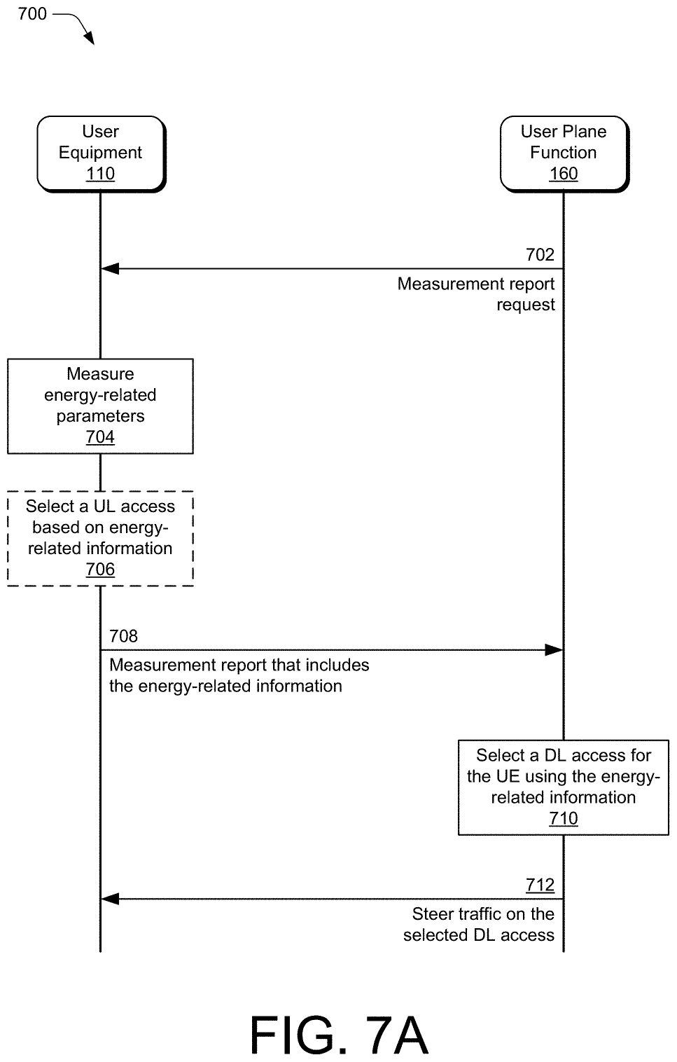

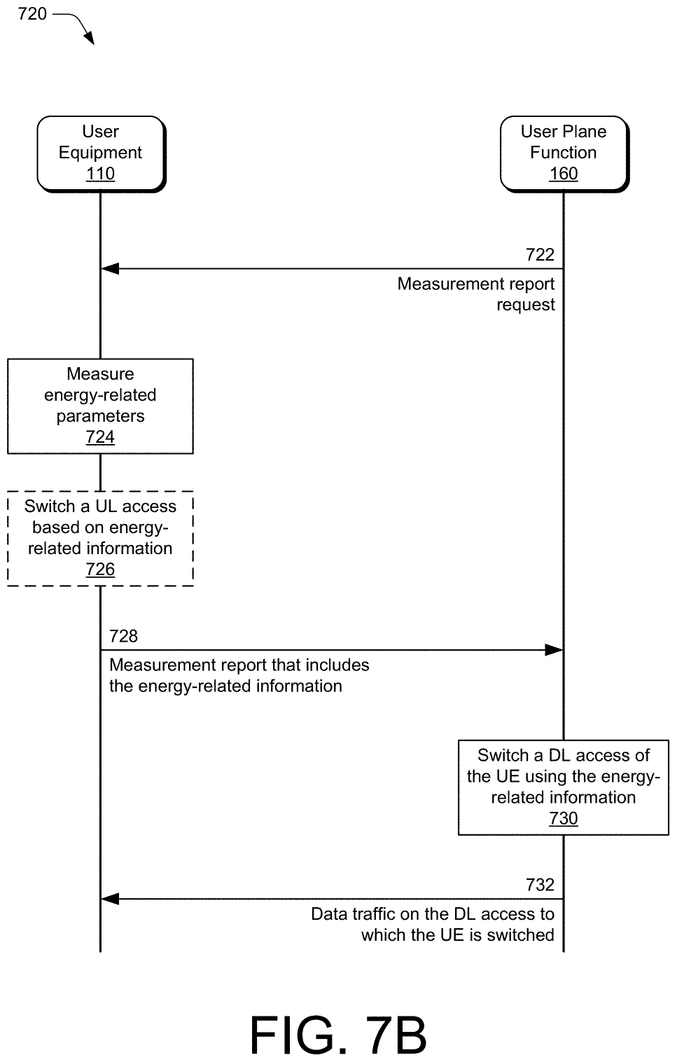

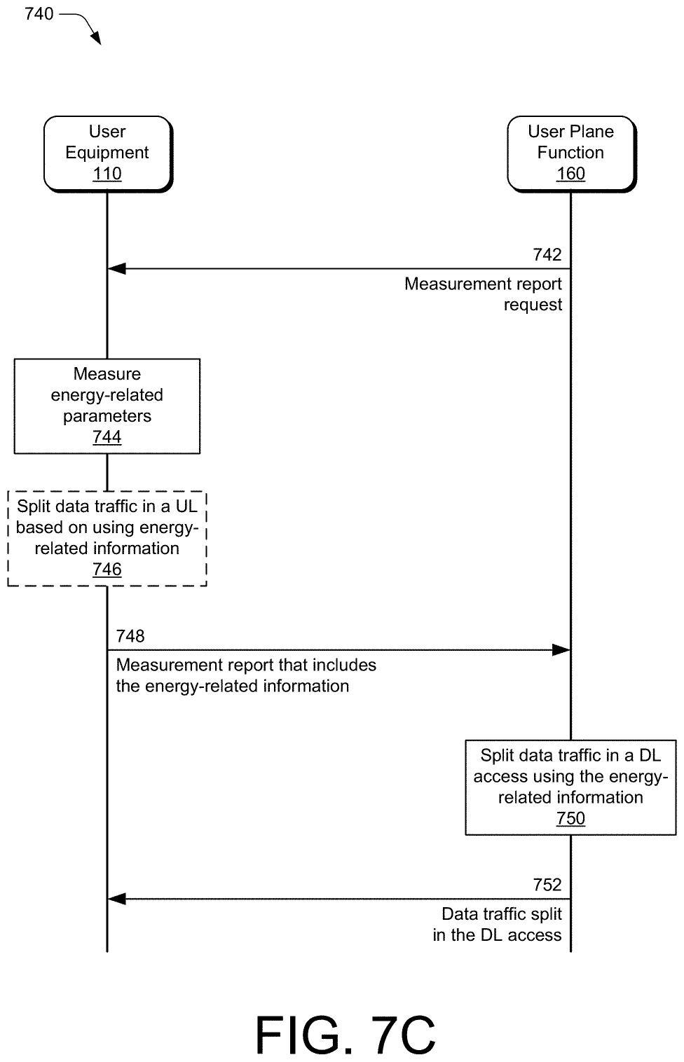

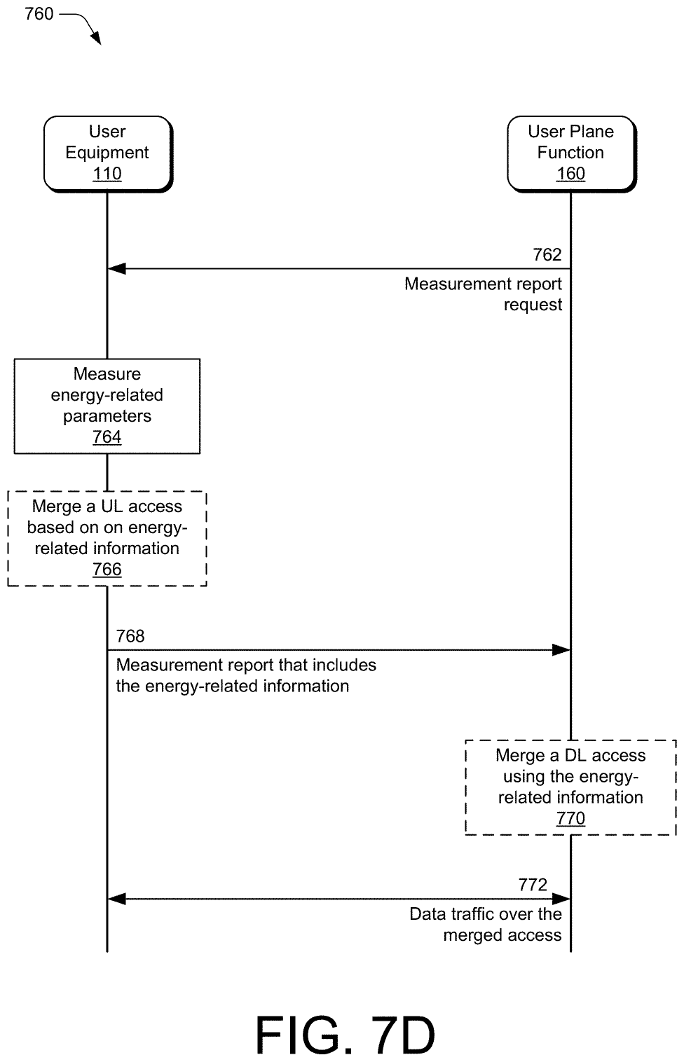

Alternatively or in addition, the PCF 270 may provide non-energy-aware ATSSS rules or steering modes that are modified to enable the user equipment 110 to perform various aspects of energy-aware traffic management, such as the control, signaling, and/or method operations described with reference to FIGS. 7-14. The PCF 270 may also provide respective ATSSS policies to the user equipment 110 and UPF 160 that include an indication of multi-path TCP or ATSSS lower-layer (ATSSS-LL) steering functionality, measurement assistance information, or network steering functionality information. For ATSSS-LL steering functionality, the measurement assistance information provides network addresses for reporting respective measurements for cellular and non-cellular accesses. For multi-path TCP steering functionality, the network steering function information indicates user equipment IP address and proxy network IP addresses useful for communication between the user equipment and core network.

The base station 120 and N3IWF 210 connect to the AMF 150 for control-plane signaling via N2 interfaces at 227 and 228, respectively. With reference to cellular access 204, the user equipment connects to the base station 120 and the AMF 150, respectively, via an N2 interface and N1 interface at 229 and 230. The base station 120 can route or tunnel user-plane traffic of the user equipment 110 to the UPF via the N3 interface at 220, such as in accordance with various aspects of energy-aware traffic management. The non-cellular access 180 can provide non-cellular access (e.g., non-3GPP access) via an untrusted access or trusted access. In this example, the non-cellular access 180 is configured as an untrusted access that connects to the AMF 150 and UPF 160 of the 5G core via the N3IWF 210. The non-cellular access 180 connects to the user equipment 110 and the N3IWF 210, respectively, via a Y1 interface and Y2 interface at 231 and 232. The user equipment 110 connects to the N3IWF 210 and AMF 150 via respective NWu and N1 interfaces at 233 and 234. The N3IWF 210 or a trusted non-3GPP gateway can route or tunnel user-plane traffic of the user equipment 110 to the UPF via the N3 interface at 221, such as in accordance with various aspects of energy-aware traffic management.

Alternatively or in addition, the non-cellular access 180 may include a trusted non-3GPP gateway function (TNGF) that connects to the AMF 150 and UPF 160 via respective N1, N2, and N3 interfaces without an intervening N3IWF 210. For example, a trusted non-3GPP access network (TNAN, not shown) may include the TNGF and a trusted non-3GPP access point (TNAP, e.g., AP 190), through which the user equipment 110 can transfer data over the trusted non-3GPP access. The user equipment 110 connects to the TNAP via a Yt interface and connects, through the TNAP, to the TNGF via a NWt interface. The user equipment 110 also connects, through the TNAN, to the AMF 150 via an N1 interface. The TNGF in turn connects to the AMF via an N2 interface and can route or tunnel user-plane traffic of the user equipment 110 to the UPF via the N3 interface, such as in accordance with various aspects of energy-aware traffic management.

Although illustrated as providing connectivity through the base station 120 and non-cellular access 180, the 5G core of the PLMN 202 may provide connectivity to the user equipment through any suitable number or combination of cellular access or non-cellular accesses. For example, the user equipment 110 may establish concurrent data sessions over a RAN and a trusted non-cellular access network of a 5G wireless network. Alternatively or in addition, control and data communications of the user equipment 110 and core network functions may traverse one or more intermediate entities of the environment 200 via corresponding the interfaces shown in FIG. 2. For example, the user equipment 110 may communicate with the UPF 160 through the non-cellular access 180 and N3IWF 210 via the NWu interface and N3 interface at 233 and 221, respectively. Accordingly, communication between various entities described herein can be implemented using any suitable path through corresponding network connections, nodes, reference points, interfaces, and/or relays, such as those described with reference to FIG. 2.

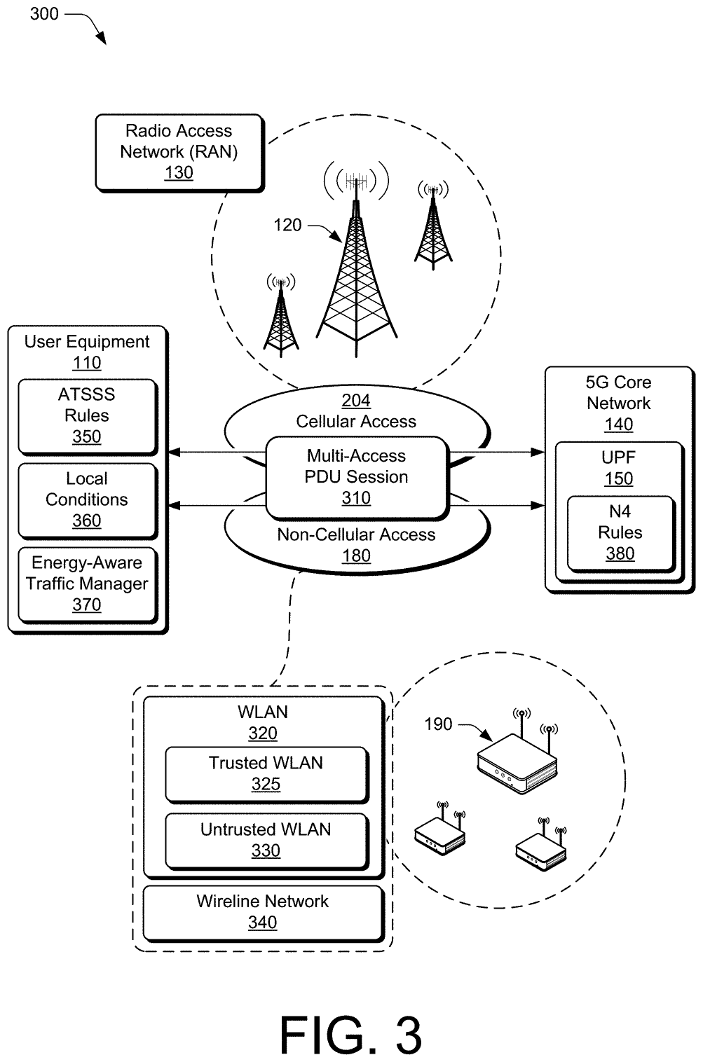

FIG. 3 illustrates at 300 an example of a multi-access data session between a user equipment and core network that is implemented in accordance with one or more aspects. The user equipment 110 establishes and communicates data traffic with the 5G core network 140 through a multi-access protocol data unit (PDU) session 310 (MA-PDU 310). To do so, the UPF 160 can interact with the SMF 260 of the 5G core network to establish or modify respective data sessions over one or more concurrent cellular or non-cellular accesses to facilitate the multi-access PDU session 310. Generally, the user equipment 110 and 5G core network 140 implement the multi-access PDU session 310 as a PDU session in which data flows (e.g., service data flows) are served over respective uplinks and downlinks of the cellular and/or non-cellular accesses. Context information for a data session, which can be transferred between the cellular and non-cellular accesses, includes context related to protocols such as Transmission Control Protocol (TCP), User Datagram Protocol (UDP) and/or Internet Protocol (IP), an IP address, user identity information, Quality-of-Service (QoS) parameters, port numbers, or the like.

In this example, data traffic of the user equipment 110 can be transferred via the cellular access 204, which is illustrated as the RAN 130 (e.g., NR RAN) that includes one or more base stations 120. Alternatively or in addition, the data traffic of the user equipment 110 can be transferred via the non-cellular access 180, which is illustrated as a WLAN 320 of WLAN access points 190. The WLAN 320 of the non-cellular access 180 may be implemented as a trusted WLAN network 325 associated with a network operator (e.g., TNAN) or an untrusted WLAN 330 that is not associated with the network operator. Alternatively, non-cellular access 180 may include a wireline network 340 through which the user equipment 110 communicates with the 5G core network 140.

The multi-access PDU session 310 is established and managed in accordance with access traffic steering, switching, and splitting rules 350 (ATSSS rules 350) and N4 rules 380 implemented by the user equipment 110 and UPF 160, respectively. The N4 rules used by the UPF 160 can correspond to the ATS SS rules 350 of the user equipment 110. As described herein, the ATSSS rules and energy-aware enhancements may apply to either or both rules sets applied at the user equipment 110 or UPF 160 for data traffic management. The SMF 260 may derive the N4 rules from policy and charging control rules (PCC rules) and ATSSS policy control information provided by the PCF 270. The ATSSS rules 350 and N4 rules 380 specify traffic steering functionalities and steering modes by which the user equipment 110 and UPF 160 transfer data traffic over the cellular access 204 and non-cellular access 180 via the multi-access PDU session 310.

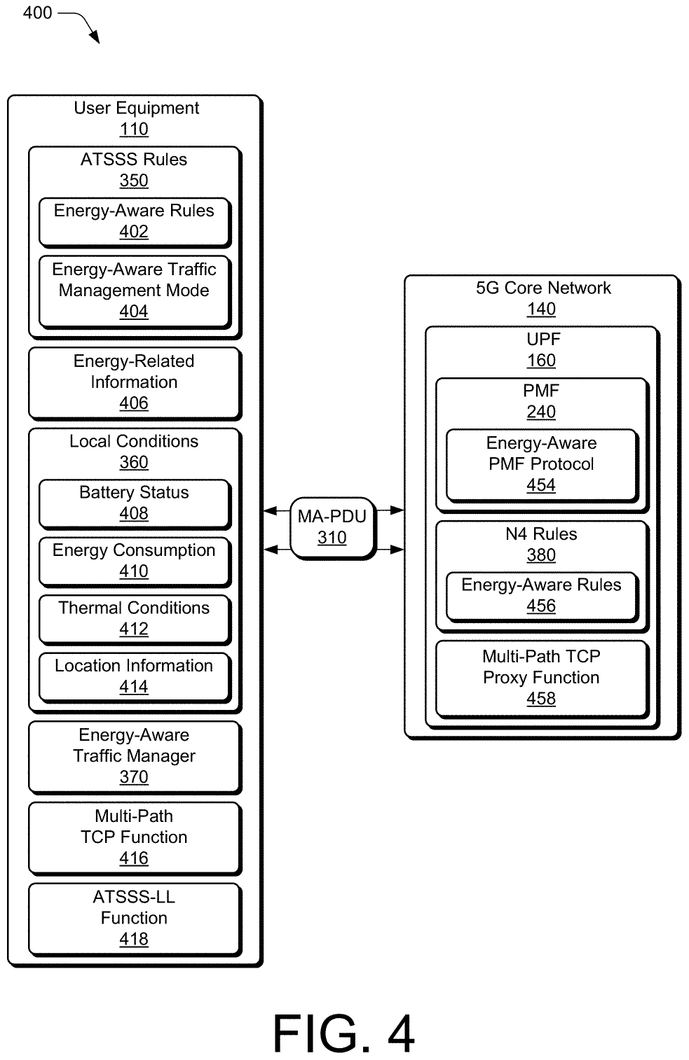

Generally, an ATSSS steering mode specifies how the user equipment 110 and/or UPF 160 distributes (e.g., steers, switches, or splits) traffic for a particular data flow, such as a service data flow (SDF) of the user equipment 110, over respective uplinks and downlinks of the cellular access 204 (e.g., a 3GPP access) and the non-cellular access 180. In addition to the energy-aware traffic management modes described herein, the user equipment 110 can be configured to implement other non-energy-aware traffic steering modes (e.g., ATSSS steering modes), which include an active-standby mode, a smallest delay mode, a load-balancing mode, a priority-based mode, or the like. In aspects, the ATSSS rules 350 and N4 rules 380 may include energy-aware traffic management rules 402 and 456 that enable the user equipment 110 to steer, switch, and/or split traffic based on local conditions 360 of the user equipment, such as a battery level, component temperature, or other energy-related parameters. In some aspects, the energy-aware traffic management rules 402 specify when the user equipment 110 can override a non-energy-aware traffic steering mode based on user equipment energy or local conditions 360. Alternatively or in addition, the energy-aware traffic rules 456 may enable the UPF 160 to steer, switch, or split downlink traffic based on energy-aware messages (e.g., PMF protocol messages) received from the user equipment 110. To implement energy-aware or energy-conscious traffic management, the user equipment 110 may include an energy-aware traffic manager 370, which is described in more detail with reference to FIG. 4.

FIG. 4. illustrates example configurations of the user equipment 110 and the 5G core network 140 of FIG. 3, including components to implement various aspects of energy-aware traffic management for multi-access data sessions. Although described with reference to the user equipment or core network, the components shown in FIG. 4 may be embodied on other entities or distributed across multiple entities of a wireless network to implement energy-aware traffic management. In aspects, the user equipment 110 is implemented with ATSSS rules 350 that include energy-aware rules 402 and an energy-aware traffic management mode 404, which enable the user equipment 110 to manage data traffic across different access technologies based on energy-related information 406. The energy-aware traffic management mode 404 may specify how and when the user equipment 110 steers, switches, or splits data traffic over cellular access 204 and/or non-cellular access 180 based on local conditions 360 or energy-related information 406 of the user equipment. For example, the energy-aware rules 402 may specify how or when the user equipment 110 overrides an active traffic steering mode (e.g., in-use or currently selected ATSSS steering mode) based on energy-related information 406, such as in response to a low battery level or user equipment overheating. Alternatively or in addition, the energy-aware traffic management mode 404 may direct or cause the user equipment 110 to steer, switch to, or split data traffic in an uplink of an access that consumes a lower amount of energy of the user equipment (e.g., a lower-energy access) to communicate data traffic with a wireless network.

The energy-related information 406 is determined from the local conditions 360 of the user equipment 110, which include a battery status 408, energy consumption 410, thermal conditions 412, location information 414, or other energy-related characteristics. The battery status 408 can indicate a remaining battery capacity, battery capacity level, or an amount of energy remaining in a battery or battery pack of the user equipment 110. The energy consumption 410 includes respective levels of energy consumed by components of the user equipment. For example, the energy consumption 410 may include a level of energy consumed by a cellular transceiver to communicate data traffic via a cellular access and another level of energy consumed by a non-cellular transceiver to communicate the data traffic via a non-cellular access. In some aspects, the energy-aware traffic manager determines a level of energy consumption for a cellular or non-cellular transceiver based on an amount data scheduled or projected for transmission by the user equipment and a data rate of the respective access network.

The thermal conditions 412 may indicate that a component of the user equipment 110, such as a processor or transceiver, is overheating and may result in loss of user equipment functionality if energy consumption is not reduced. Alternatively, the thermal conditions may indicate that the user equipment 110 is overheating or that functionality of the user equipment is or will become impaired if energy consumption of the user equipment is not reduced. Location information 414 includes a geographic location of the user equipment, which is useful to determine relative distance to other network entities (e.g., base station or access point) and estimate respective transmit power used to communicate with those entities.

In aspects, the energy-aware traffic manager 370 interacts with components of the user equipment 110 to determine energy-related information 406 of the user equipment 110 to implement energy-aware traffic management for multi-access data sessions. For example, the energy-aware traffic manager 370 monitors a battery status 408 and thermal conditions 412 to determine when to activate the energy-aware traffic management mode 404 or override another steering mode to facilitate selection of, switching to, or splitting in a lower-energy access to conserve energy of the user equipment. Steering functionality options of the user equipment for higher layer or lower layer traffic steering include multi-path TCP function 416 and ATSSS lower-layer function 418, which is applicable to higher layers of traffic. The multi-path TCP protocol is carried out above an IP layer in the protocol stack and enables communication with a multi-path TCP proxy of the UPF 160 to implement energy-aware management of TCP traffic.

The 5G core network 140 includes a UPF 160 with a performance measurement function 240 (PMF 240) for measuring various parameters associated with communicating with the user equipment 110 over multiple accesses. In aspects, the PMF 240 of the UPF 160 is configured to implement an energy-aware PMF protocol 454 that enables the user equipment 110 to report or indicate energy-based parameters to the UPF 160, such as energy related information 406 derived from the local conditions 360 of the user equipment. In some cases, the energy-aware PMF protocol 454 includes measurement reporting for critical conditions or events of user equipment energy (e.g., overheating or low battery level), a type of the critical condition, cessation of the critical condition, a field or information element configured to indicate a preferred downlink, a ratio for splitting downlink traffic, or the like. The energy-aware PMF protocol 454 can also include enhanced access availability reporting, which enables the user equipment 110 to report, to the UPF 160, a non-preferred access as unavailable to cause or direct (e.g., request) the UPF 160 to select or switch to an access preferred by the user equipment from an energy perspective. Alternatively or in addition, the PCF 270 can be configured to allow or disallow the energy-aware measurement reporting, or limit a frequency at which the user equipment 110 sends notifications, or reports relating to user equipment energy, such as notifications of critical user equipment energy condition or events.

The 5G core network 140 may also include an instance of the N4 rules 380 with energy-aware rules 456 that enable the core network to manage data traffic across the different access technologies based on energy-related information 406 of the user equipment 110. For example, the energy-aware rules 456 of the N4 rules 380 may specify how or when the UPF 160 redirects downlink traffic of the user equipment 110 to an access that corresponds to a lower-energy access selected by the user equipment. A multi-path TCP proxy function 458 enables communication with the user equipment 110 via the multi-path TCP function 416 to coordinate energy-aware management of TCP traffic over the cellular access 204 and non-cellular access 180.

Example Devices

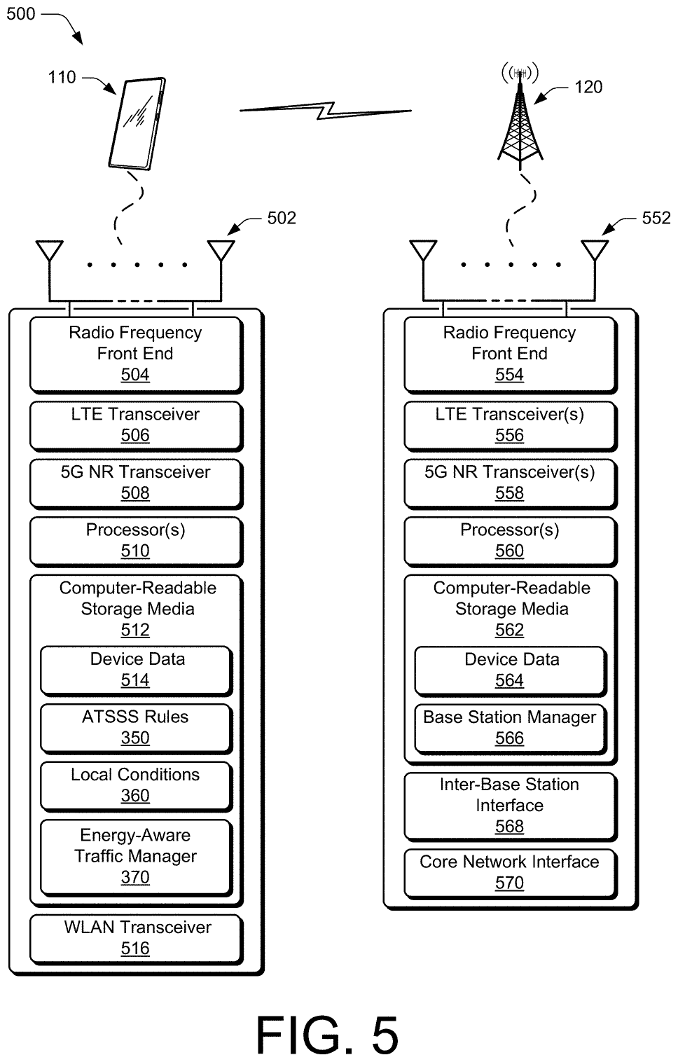

FIG. 5 illustrates an example device diagram 500 of the user equipment 110 and the base stations 120 of the cellular access 204. The user equipment 110 and the base stations 120 may include additional functions and interfaces that are omitted from FIG. 5 for the sake of clarity. The user equipment 110 includes antennas 502, a radio frequency front end 504 (RF front end 504), an LTE transceiver 506, and a 5G NR transceiver 508 for communicating with base stations 120 of a 5G NR access or other cellular accesses of the RAN 130. The RF front end 504 of the user equipment 110 can couple or connect the LTE transceiver 506 and the 5G NR transceiver 508 to the antennas 502 to facilitate various types of wireless communication. The antennas 502 of the user equipment 110 may include an array of multiple antennas that are configured similar to or differently from each other. The antennas 502 and the RF front end 504 can be tuned to, and/or be tunable to, one or more frequency bands defined by the 3GPP LTE and 5G NR communication standards and implemented by the LTE transceiver 506, and/or the 5G NR transceiver 508. Additionally, the antennas 502, the RF front end 504, the LTE transceiver 506, and/or the 5G NR transceiver 508 may be configured to support beamforming for the transmission and reception of communications with the base stations 120. By way of example and not limitation, the antennas 502 and the RF front end 504 can be implemented for operation in sub-gigahertz bands, sub-6 GHZ bands, and/or above 6 GHz bands that are defined by the 3GPP LTE and 5G NR communication standards.

The user equipment 110 also includes processor(s) 510 and computer-readable storage media 512 (CRM 512). The processor 510 may be a single core processor or a multiple core processor composed of a variety of materials, such as silicon, polysilicon, high-K dielectric, copper, and so on. The computer-readable storage media described herein excludes propagating signals. CRM 512 may include any suitable memory or storage device such as random-access memory (RAM), static RAM (SRAM), dynamic RAM (DRAM), non-volatile RAM (NVRAM), read-only memory (ROM), or Flash memory useable to store device data 514 of the user equipment 110. The device data 514 includes user data, multimedia data, beamforming codebooks, applications, and/or an operating system of the user equipment 110, which are executable by processor(s) 510 to enable user-plane communication, control-plane signaling, and user interaction with the user equipment 110.

CRM 512 also includes instances of ATSSS rules 350, local conditions 360, and an energy-aware traffic manager 370, which may be implemented in accordance with various aspects described herein. Alternately or additionally, the energy-aware traffic manager 370 may be implemented in whole or part as hardware logic or circuitry integrated with or separate from other components of the user equipment 110. In at least some aspects, the energy-aware traffic manager 370 configures the RF front end 504, the LTE transceiver 506, and/or the 5G NR transceiver 508 to implement the techniques for energy-aware traffic management as described herein.

The user equipment 110 includes a WLAN transceiver 516 that implements the functions of a WLAN station (STA). The WLAN transceiver 516 may be coupled to the RF front end 504 and antennas 502, may include an RF front end and antennas, or both. The energy-aware traffic manager 370 may control the configuration and operation of the 5G NR transceiver 508 and the WLAN transceiver 516 to coordinate operation in the WLAN and cellular frequency bands, or the configuration and operation of the 5G NR transceiver 508 and WLAN transceiver 516 may be distributed between the energy-aware traffic manager 370 and the respective transceivers in any suitable manner. The WLAN transceiver 516 is configured to operate in any WLAN frequency band and using any protocols defined in the IEEE 802.11 specifications. The WLAN transceiver 516 may also be configured to support beamformed communication.

The device diagram for the base stations 120, shown in FIG. 5, includes a single network node (e.g., a gNode B). The functionality of the base stations 120 may be distributed across multiple network nodes or devices and may be distributed in any fashion suitable to perform the functions described herein. The base stations 120 include antennas 552, a radio frequency front end 554 (RF front end 554), one or more LTE transceivers 556, and/or one or more 5G NR transceivers 558 for communicating with the user equipment 110. The RF front end 554 of the base stations 120 can couple or connect the LTE transceivers 556 and the 5G NR transceivers 558 to the antennas 552 to facilitate various types of wireless communication. The antennas 552 of the base stations 120 may include an array of multiple antennas that are configured similar to or differently from each other. The antennas 552 and the RF front end 554 can be tuned to, and/or be tunable to, one or more frequency band defined by the 3GPP LTE and 5G NR communication standards, and implemented by the LTE transceivers 556, and/or the 5G NR transceivers 558. Additionally, the antennas 552, the RF front end 554, the LTE transceivers 556, and/or the 5G NR transceivers 558 may be configured to support beamforming, such as Massive-MIMO, for the transmission and reception of communications with the user equipment 110.

The base stations 120 also include processor(s) 560 and computer-readable storage media 562 (CRM 562). The processor 560 may be a single core processor or a multiple core processor composed of a variety of materials, such as silicon, polysilicon, high-K dielectric, copper, and so on. CRM 562 may include any suitable memory or storage device such as RAM, SRAM, DRAM, NVRAM, ROM, or Flash memory useable to store device data 564 of the base stations 120. The device data 564 includes network scheduling data, radio resource management data, beamforming codebooks, applications, and/or an operating system of the base stations 120, which are executable by processor(s) 560 to enable communication with the user equipment 110.

CRM 562 also includes a base station manager 566. Alternately or additionally, the base station manager 566 may be implemented in whole or part as hardware logic or circuitry integrated with or separate from other components of the base stations 120. In at least some aspects, the base station manager 566 configures the LTE transceivers 556 and the 5G NR transceivers 558 for communication with the user equipment 110, as well as communication with a core network. The base stations 120 include an inter-base station interface 568, such as an Xn and/or X2 interface, which the base station manager 566 configures to exchange user-plane and control-plane data between another base station 120, to manage the communication of the base stations 120 with the user equipment 110. The base stations 120 include a core network interface 570 that the base station manager 566 configures to exchange user-plane and control-plane data with core network functions and entities. This core network interface 570 may include interfaces for connections with a 5G core network, such as the N1 and N2 interfaces as described with reference to FIG. 2.

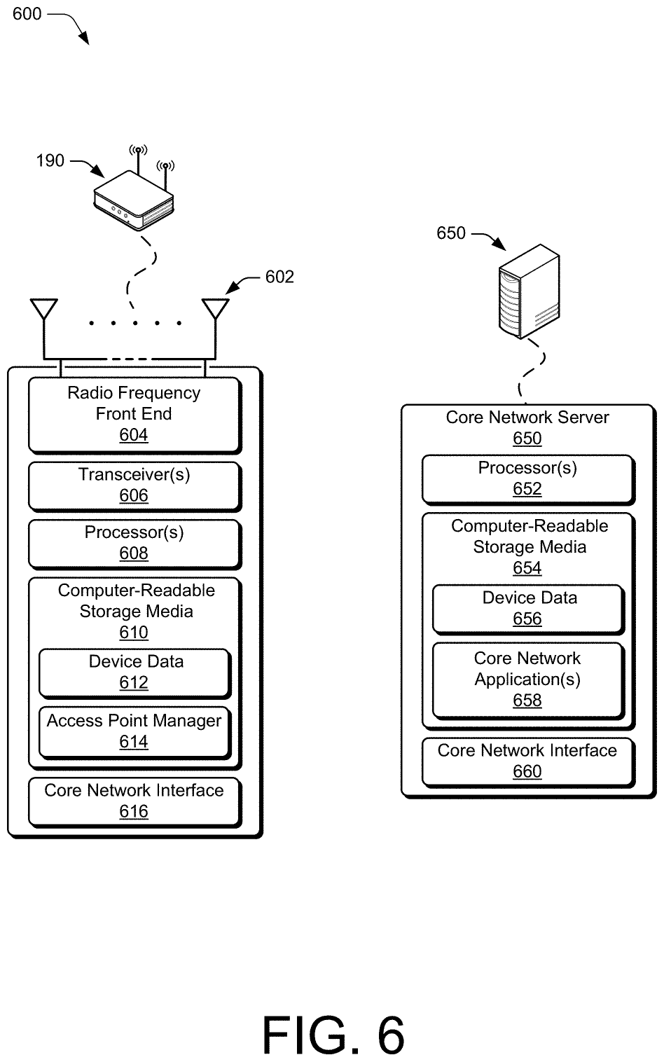

FIG. 6 illustrates at 600 an example device diagram of the WLAN AP 190 and a core network server 650. The WLAN AP 190 and a core network server 650 may include additional functions and interfaces that are omitted from FIG. 5 for the sake of clarity. The WLAN AP 190 includes antennas 602, a radio frequency front end 604 (RF front end 604), one or more transceivers 606 that are configured for WLAN communication with the user equipment 110. The RF front end 604 can couple or connect the transceivers 606 to the antennas 602 to facilitate various types of wireless communication. The antennas 602 of the WLAN AP 190 may include an array of multiple antennas that are configured similarly to or differently from each other. The antennas 602 and the RF front end 604 can be tuned to, and/or be tunable to, one or more frequency bands defined by the IEEE 802.11 communication standards (e. g. , Wi-Fi 6E) and implemented by the transceivers 606. Additionally, the antennas 602, the RF front end 604, and/or the transceivers 606 may be configured to support beamforming for the transmission and reception of communications with the user equipment 110.

The WLAN AP 190 also includes processor(s) 608 and computer-readable storage media 610 (CRM 610). The processor 608 may be a single core processor or a multiple core processor composed of a variety of materials, such as silicon, polysilicon, high-K dielectric, copper, and so on. CRM 610 may include any suitable memory or storage device such as RAM, SRAM, DRAM, NVRAM, ROM, or Flash memory useful to store device data 612 of the WLAN AP 190. The device data 612 includes network scheduling data, radio resource management data, applications, and/or an operating system of the WLAN AP 190, which are executable by processor(s) 608 to enable communication with the user equipment 110.

CRM 610 also includes an access point manager 614, which, in one implementation, is embodied on CRM 610 (as shown). Alternately or additionally, the access point manager 614 may be implemented in whole or part as hardware logic or circuitry integrated with or separate from other components of the WLAN AP 190. In at least some aspects, the access point manager 614 configures the transceivers 606 for communication with the user equipment 110, as well as communication of user-plane and control-plane data with gateway functions, such as N3IWF, of the core network 140 via a core network interface 616.

The core network server 650 may provide all or part of a function, entity, service, and/or gateway in the core network 140 enabling through cellular access 204 or non-cellular access 180. Each function, entity, service, and/or gateway in the core network 140 may be provided as a service in the core network 140, distributed across multiple servers, or embodied on a dedicated server. For example, the core network server 650 may provide all or a portion of the services or functions of the AMF 150, UPF 160, PCF 270, SMF 260, N3IWF 210, or other non-cellular gateway functions. The core network server 650 is illustrated as being embodied on a single server that includes processor(s) 652 and computer-readable storage media 654 (CRM 654). The processor 652 may be a single core processor or a multiple core processor composed of a variety of materials, such as silicon, polysilicon, high-K dielectric, copper, and so on. CRM 654 may include any suitable memory or storage device such as RAM, SRAM, DRAM, NVRAM, ROM, magnetic media drives, or Flash memory useful to store device data 656 of the core network server 650. The device data 656 includes data to support a core network function or entity, and/or an operating system of the core network server 650, which are executable by processor(s) 652.

CRM 654 also includes one or more core network applications 658, which, in one implementation, is embodied on CRM 654 (as shown). The one or more core network applications 658 may implement the functionality of the AMF 150, UPF 160, PCF 270, SMF 260, N3IWF 210, or other non-cellular gateway functions (e.g., a trusted WLAN gateway). Alternately or additionally, the one or more core network applications 658 may be implemented in whole or part as hardware logic or circuitry integrated with or separate from other components of the core network server 650. The core network server 650 also includes a core network interface 660 for communication of user-plane and control-plane data with the other functions or entities in the core network 140, base stations 120, or WLAN 320, using any of the network interfaces described herein.

Energy-Aware Traffic Management Operations

To overcome energy-related issues, such as reduced run time and overheating, the energy-aware traffic manager 370 routes data traffic of the user equipment 110 over different uplink and downlink accesses based on energy-related information. In aspects, the energy-aware traffic manager 370 uses energy-aware traffic management modes, steering mode enhancements, or measurement reporting to route or direct the data traffic over a lower-energy access. By so doing, energy consumption by the user equipment 110 is reduced, which can extend user equipment runtime or mitigate effects associated with user equipment overheating.

FIGS. 7A through FIG. 9 provide some examples of wireless network access steering, switching, and splitting enabled through one or more aspects of energy-aware traffic management. The described examples include energy-aware implementations of traffic steering to select an access to steer new data flows over and traffic switching to handover data traffic from one access to another access. The examples also include energy-aware aspects of traffic splitting to split data traffic between aggregate bandwidth of multiple accesses and access merging that combines split accesses to provide a single access for transferring data traffic.

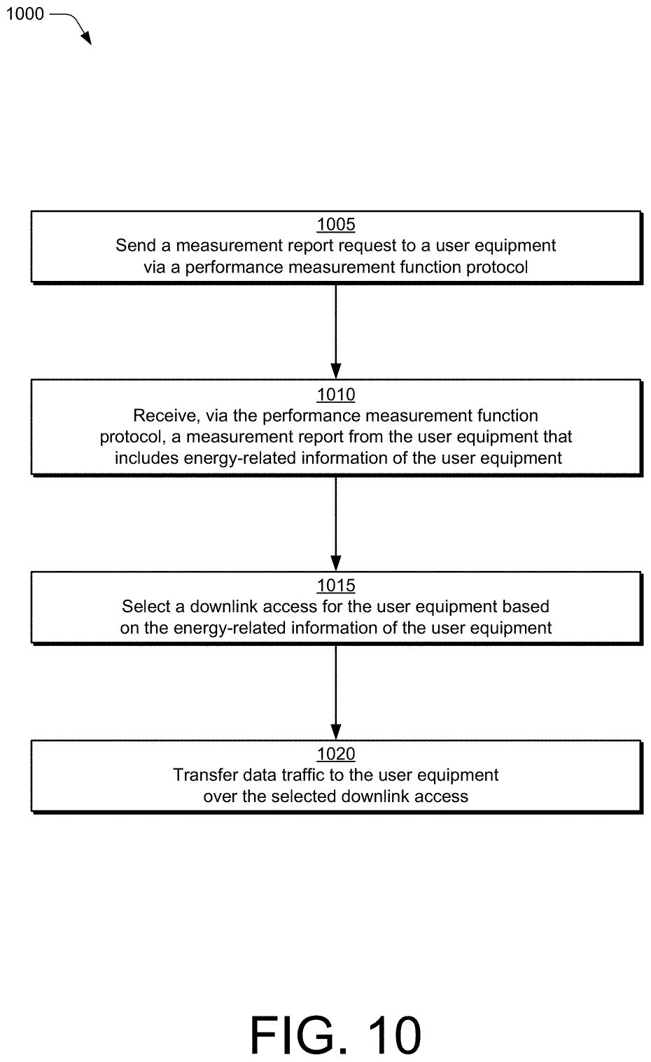

Various operations described with reference to FIGS. 7A through FIG. 9 can be performed by any entity described with reference to FIGS. 1-6, combined with operations of other examples of FIGS. 7A through FIG. 9, or combined with operations of the methods illustrated in FIGS. 10-14. For example, a user equipment 110 can steer a new data traffic flow over an uplink of the cellular access 204 that is selected based on a battery level of the user equipment being above a predefined threshold. In response to the battery level falling below the predefined threshold, the user equipment 110 can switch the data traffic to an uplink of the non-cellular access 180, or split the data traffic between the uplink of the cellular access 204 and the non-cellular access 180 in accordance with the described aspects of energy-aware traffic management to reduce energy consumption of the user equipment.

Generally, FIGS. 7A through FIG. 9 illustrate example details of data and control transactions between devices that communicate through cellular or non-cellular accesses via one or more mobile-originated data uplinks and one or more mobile-terminated data downlinks. In the context of the example environments 100, 200, and examples of FIGS. 7A through FIG. 9, the user equipment 110 transmits data traffic to the UPF 160 of the 5G core network 140 via one or more mobile-originated data uplinks provided through the RAN 130 (cellular access 204) and/or WLAN 320 (non-cellular access 180). An amount of energy consumption of the user equipment 110 corresponds to the use of the mobile-originated data uplinks, which may include transmit power used to transfer the data traffic over a respective mobile-originated data uplink to a base station 120 of the RAN 130 or WLAN AP 190 of the non-cellular access 180. For example, energy consumption associated with a mobile-originated data uplink of an access may include energy used by the user equipment 110 to maintain a transmit-ready idle mode (e.g., maintain an uplink connection) of a transmitter (or transceiver), queue and process data of the user equipment for transmission, or transmit the data over the mobile-originated data uplink (e.g., wireless link) to the base station or access point of the access network. As such, energy-aware traffic management may reduce energy consumption of the user equipment 110 by steering, switching to, or splitting data traffic in a mobile-originated data uplink of an access that consumes less energy than another access to transfer data of the user equipment to the UPF 160 of the wireless network.

With reference to downlink data traffic, the user equipment 110 receives data traffic from the UPF 160 of the 5G core network 140 via the one or more mobile-terminated data downlinks provided through the RAN 130 (cellular access 204) and/or non-cellular access 180. Some amount of energy consumption of the user equipment 110 corresponds to use of these mobile-terminated data downlinks, which may include energy used to receive the data traffic over a respective mobile-terminated data downlink from a base station 120 of the RAN 130 or a WLAN AP 190 of the non-cellular access 180. For example, energy consumption associated with a mobile-terminated data downlink of an access may include energy used by the user equipment 110 to maintain a receive-ready idle mode (e.g., maintain a downlink connection) of a receiver (or transceiver), as well as to receive, decode, and queue data transferred over a mobile-terminated data downlink (e.g., wireless link) from the base station or access point of the access network.

Although this energy consumption associated with a mobile-terminated data downlink may be less than that of a data uplink (e.g., uplink transmit power), aspects of energy-aware traffic management may reduce energy consumption of the user equipment 110 by steering, switching to, or splitting data traffic in a reciprocal mobile-terminated data downlink of a same access of a selected mobile-originated data uplink of the user equipment. For example, this may enable the user equipment 110 to power down a receiver (or transceiver) for a different access while using the reciprocal uplink and downlink of the same access to transfer data traffic to and from the UPF 160. The following examples described with reference to FIG. 7A through FIG. 9 are but a few of examples of how aspects of energy-aware traffic management may be implemented to switch, steer, or split data traffic in a mobile-originated data uplink and/or a mobile-terminated data downlink to reduce energy consumption of a user equipment.

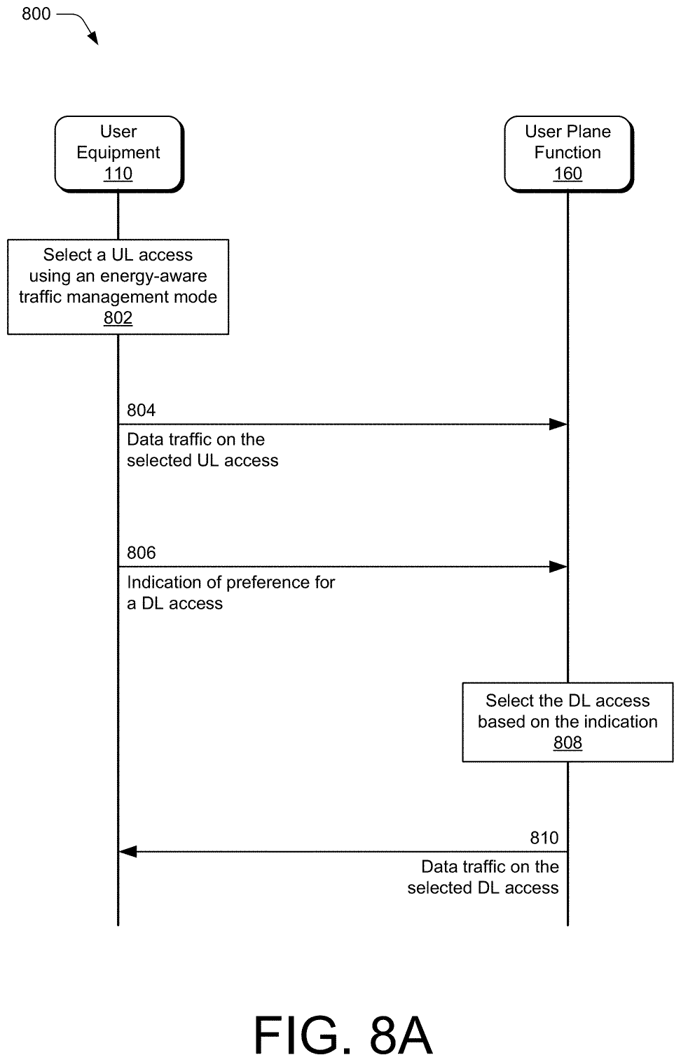

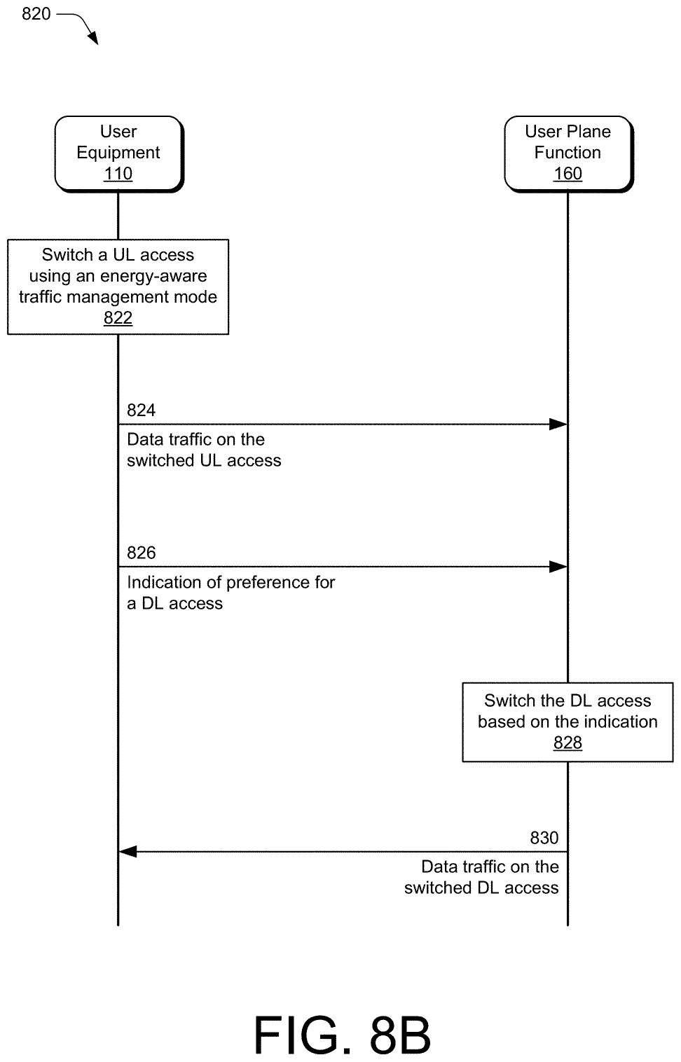

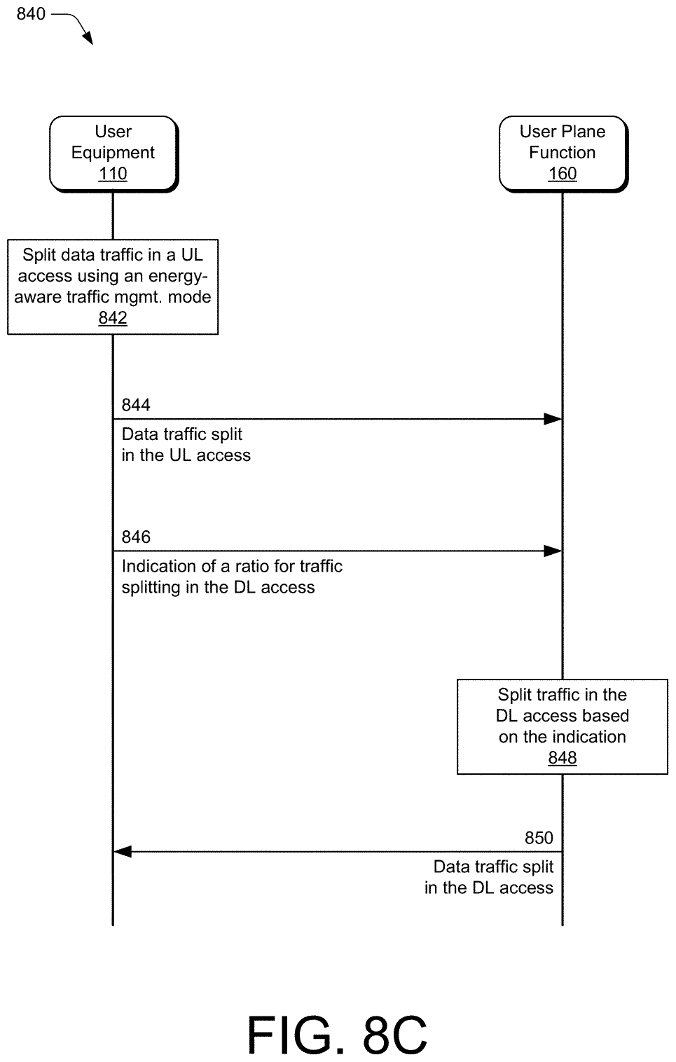

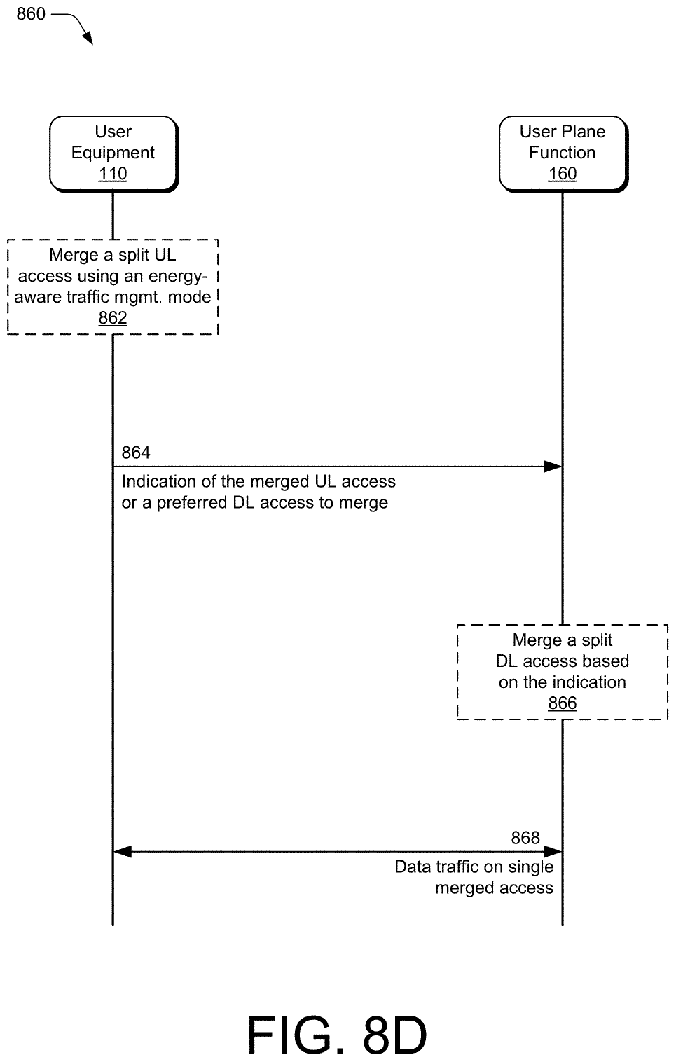

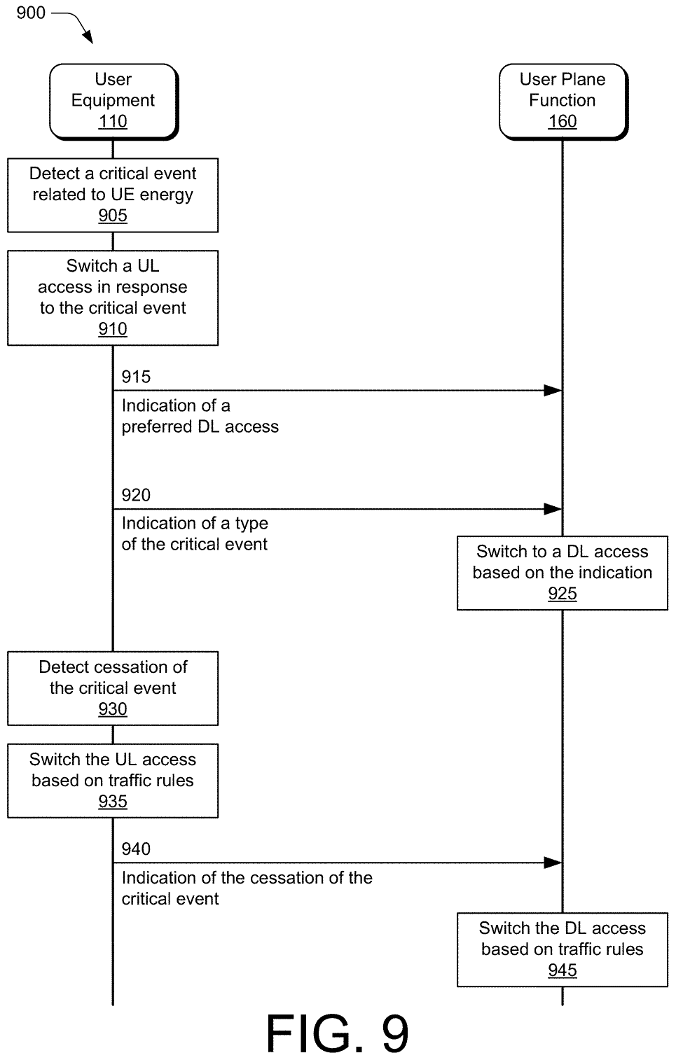

With reference to the following examples, FIG. 7A provides an example of selecting an uplink access or selecting a downlink access for steering data traffic. FIG. 7B provides an example of switching an uplink access or switching a downlink access. FIG. 7C provides an example of splitting data traffic in an uplink access or splitting data in a downlink access. FIG. 7D provides an example of merging split accesses to provide a single access for transferring data traffic. FIG. 8A provides an example of steering data traffic over an uplink access or a downlink access in accordance with an energy-aware traffic management mode. FIG. 8B provides an example of switching an uplink access or switching a downlink access in accordance with the energy-aware traffic management mode. FIG. 8C provides an example of splitting data traffic in an uplink access or a downlink access in accordance with the energy-aware traffic management mode. FIG. 8D provides an example of merging split accesses to provide a single access in accordance with the energy-aware traffic management mode. FIG. 9 provides an example of switching an uplink access and a downlink access in response to a critical event related to user equipment energy.

In the examples, the user equipment 110 and UPF 160 may exchange the data and control information using the energy-aware PMF protocol 454, which enables the user equipment to indicate, to the UPF 160, various energy-related information 406. The energy-related information may include an indication of a preferred access for a downlink to the user equipment. This indication may be effective to cause or direct the core network to select the preferred access, which may include a downlink in a same access as an uplink selected by the user equipment to conserve user equipment energy. Alternatively, the user equipment 110 may declare or indicate a non-preferred access as unavailable to the UPF 160 through an enhanced availability report, which can cause the UPF 160 to select the preferred access of the user equipment 110. The measurement reports sent by the user equipment 110 may also include energy-related information 406 of the user equipment, indicate user equipment support for energy-aware traffic management mode 404, or indicate user equipment support for various energy-related measurement reporting enhancements (e.g., energy-aware PMF protocol 454).

FIG. 7A illustrates at 700 an example of energy-aware traffic steering in which the user equipment 110 or energy-aware traffic manager 370 selects an access for steering data traffic, such as for when the user equipment initiates a new data flow (e.g., a new SDF). The example in presented in the context of a measurement report procedure, though operations described in reference to FIG. 7A for access traffic steering may be initiated or performed by either of the user equipment 110 or the UPF 160 of the 5GC 140 independent of the measurement report procedure, such as described with reference to FIG. 8A or FIGS. 10-12A.

The UPF 160 sends, at 702, a measurement report request to the user equipment 110 via the PMF 240 of the UPF 160. The measurement report request includes parameters for measurement of energy-related information 406 of the user equipment 110, such as energy consumption levels for accesses (e.g., respective transmit power), a lowest-energy access (e.g., a preferred access), or thermal conditions at the user equipment. The UPF 160 can send the measurement report request to the user equipment 110 through the non-cellular access 180 via the N3IWF 210, through a trusted non-cellular access (e.g., TNGF of a TNAN), or the cellular access 204 via the base station 120.

In response to the measurement report request, the user equipment 110 measures, at 704, energy-related parameters of the user equipment, such as local conditions 360. The user equipment 110 measures the energy-related parameters at 704 to provide energy-related information 406 of the user equipment. In some cases, the energy-aware traffic manager 370 of the user equipment 110 estimates a first level of energy consumed by a 5G NR transceiver 508 of the user equipment 110 to transfer data traffic at a particular data rate over a cellular access 204 and estimates a second level of energy consumed by a WLAN transceiver 516 of the user equipment 110 to transfer the data traffic at the particular data rate over a WLAN 320. The user equipment 110 may estimate or determine relative levels of energy consumed by the transceivers of the user equipment that are actively transmitting the data, idle (e.g., maintaining a downlink), or actively receiving data from the cellular access 204 or the WLAN 320. Alternatively or in addition, the energy-aware traffic manager 370 may collect battery status 408 information of the user equipment 110, location information 414, thermal conditions 412 of one or more components of the user equipment 110.

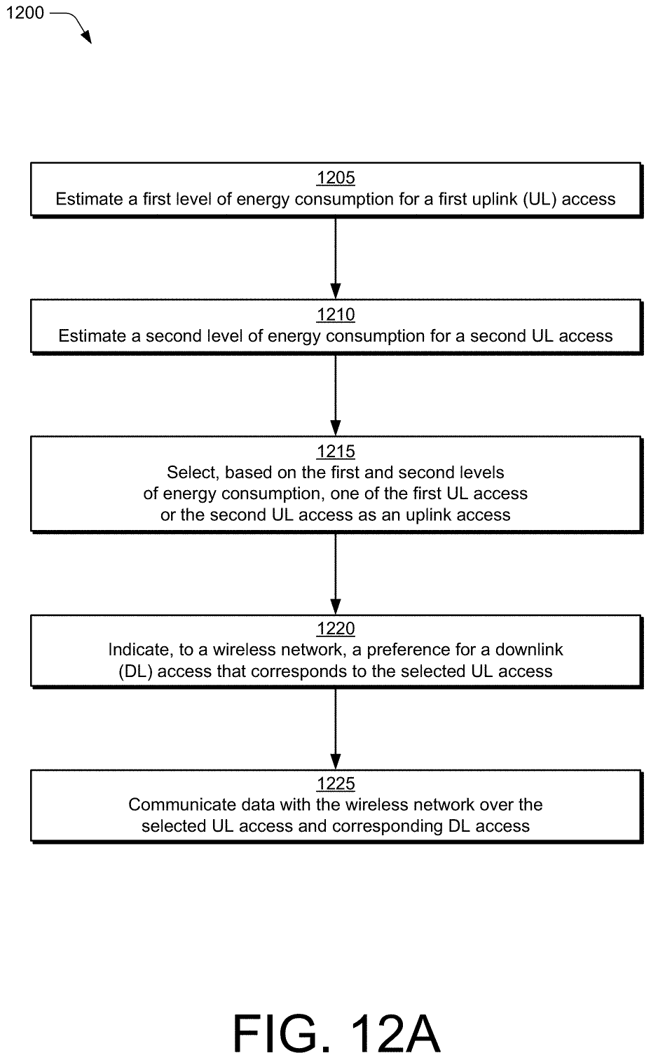

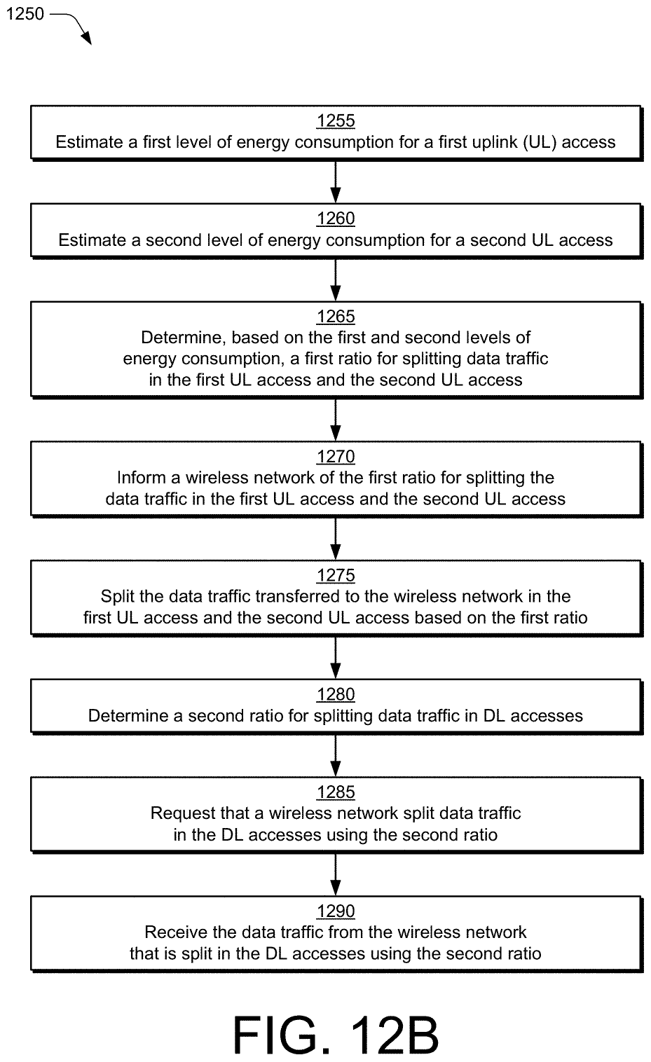

Optionally at 706, the user equipment 110 selects an uplink access, e.g., a mobile-originated data uplink, for steering a data flow based on the energy-related information 406. In some aspects, the user equipment 110 implements operations 704 and 706 independent of the measurement report procedure to select the uplink access for data traffic steering. The user equipment 110 can select the uplink access in accordance with the energy-aware traffic management mode 404, such as described with reference to FIG. 8A, or in response to measuring the energy-related parameters at 704. For example, the user equipment 110 may select the uplink access that consumes a lower amount of user equipment energy to transmit a particular amount of data to an access point 190 of the cellular access 204 or WLAN AP 190 of the WLAN 320. Note that in some circumstances, the user equipment 110 may select a higher-energy uplink access that offers a higher data rate (e.g., higher performing uplink), which in turn may reduce an amount of time used by the user equipment to transmit a given amount of data. In other words, quickly transmitting the given amount of data via the higher-energy uplink access can be more energy-efficient than transmitting the same amount of data over a lower-energy, lower-rate uplink access for a longer duration of time. Alternatively or in addition, the user equipment 110 may select an uplink access based on the energy-related information 406 and data rate requirements estimated for applications of the user equipment (e.g., minimum required data rates), such as by using the data rate estimations described with reference to FIG. 7C, FIG. 8C, or FIG. 12B.

At 708, the user equipment 110 sends, via the PMF 240, a measurement report to the UPF 160 that includes the energy-related information 406 of the user equipment. The energy-aware traffic manager 370 of the user equipment 110 can send, via the energy-aware PMF protocol 454, the measurement report to the UPF 160 to indicate the respective levels of energy consumption (e.g., transmit power) associated with transferring the data traffic over the cellular access 204 and WLAN 320, respectively. Alternatively or in addition, the energy-aware traffic manager 370 can send a measurement report to the UPF 160 that indicates a preferred access for a downlink, a selected uplink access for steering data traffic, an unavailability of a non-preferred access, a lower-energy uplink access selected by the user equipment 110 (e.g., at 1215 of FIG. 12A), the battery status, or the thermal conditions of the components of the user equipment 110. The user equipment 110 can send the measurement report to the UPF 160 through the non-cellular access 180 via the N3IWF 210, through a trusted non-cellular access (e.g., TNGF of a TNAN), or the cellular access 204 via the base station 120.

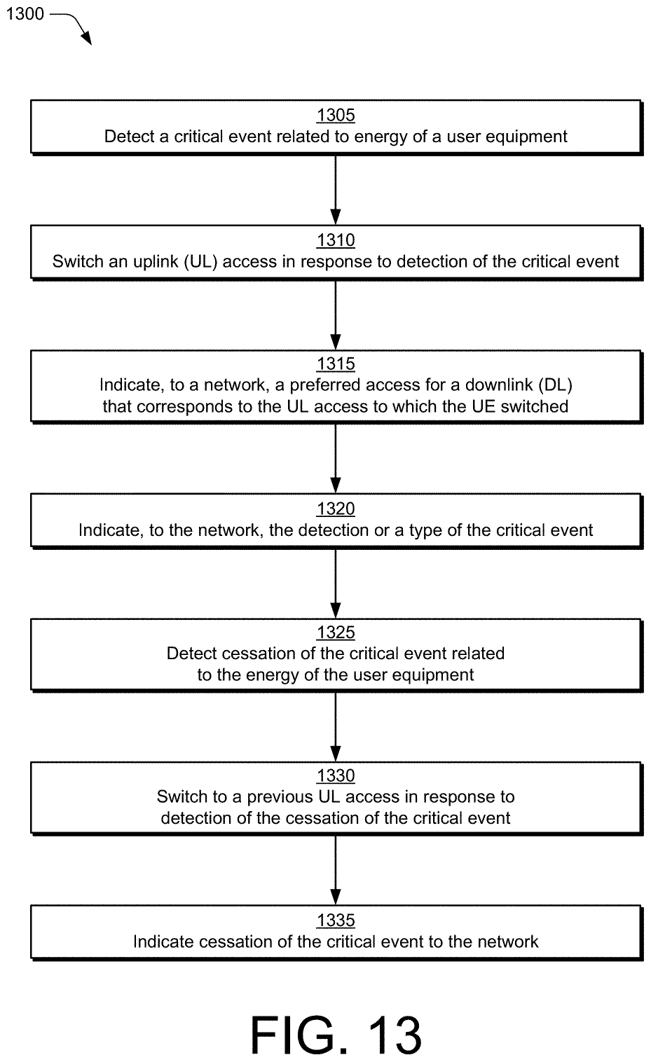

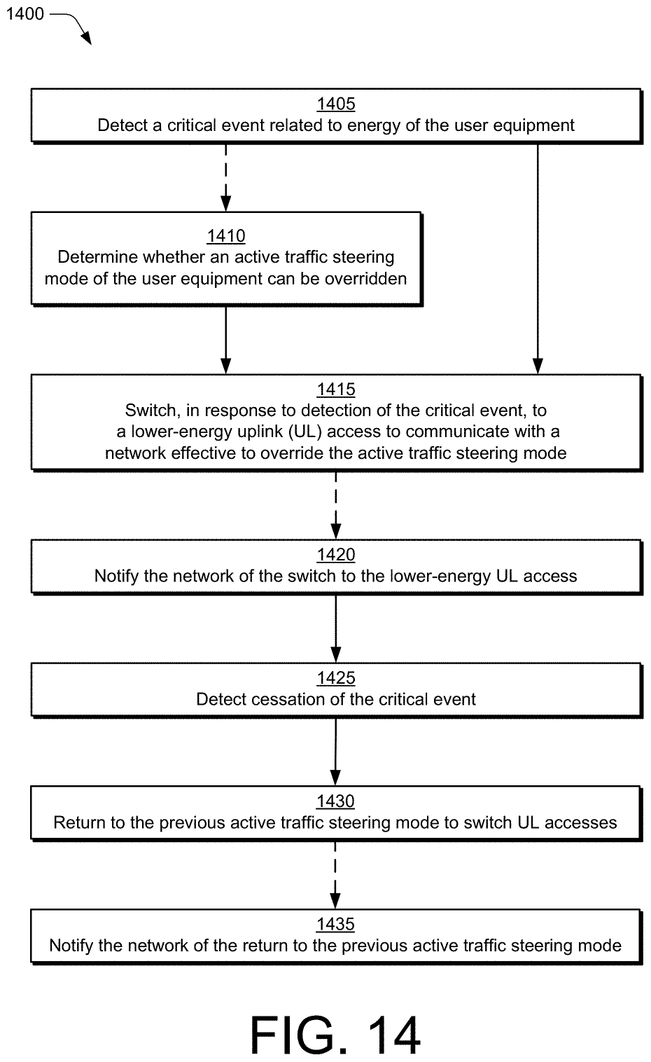

Using the energy-related information 406 of the measurement report, the UPF 160 selects, at 710, a downlink access for steering data traffic of the user equipment 110. The UPF 160 can select the downlink access that reduces energy consumption at the user equipment, such as by selecting a downlink access to correspond with a lower-energy uplink access of the user equipment. For example, selecting a reciprocal downlink in a same access as an uplink that is selected by the user equipment 110 (e.g., access merging) may enable the user equipment to place a transceiver of another access in a standby or low-power mode, thereby reducing energy consumption of the user equipment. Concluding the present example, the UPF 160 steers, at 712, data traffic of an initiated data flow to the user equipment 110 on the selected downlink access. With an uplink access or downlink access selected for steering a data flow, the user equipment may switch an access of the data flow as described with reference to FIG. 7B, FIG. 8B, FIG. 9, FIG. 13, or FIG. 14, or split the data flow in the access as described with reference to FIG. 7C, FIG. 8C, or FIG. 12B. Alternatively or in addition, the user equipment can merge split accesses as described with reference to FIG. 7D or FIG. 8D to provide a single access for communicating with the wireless network.

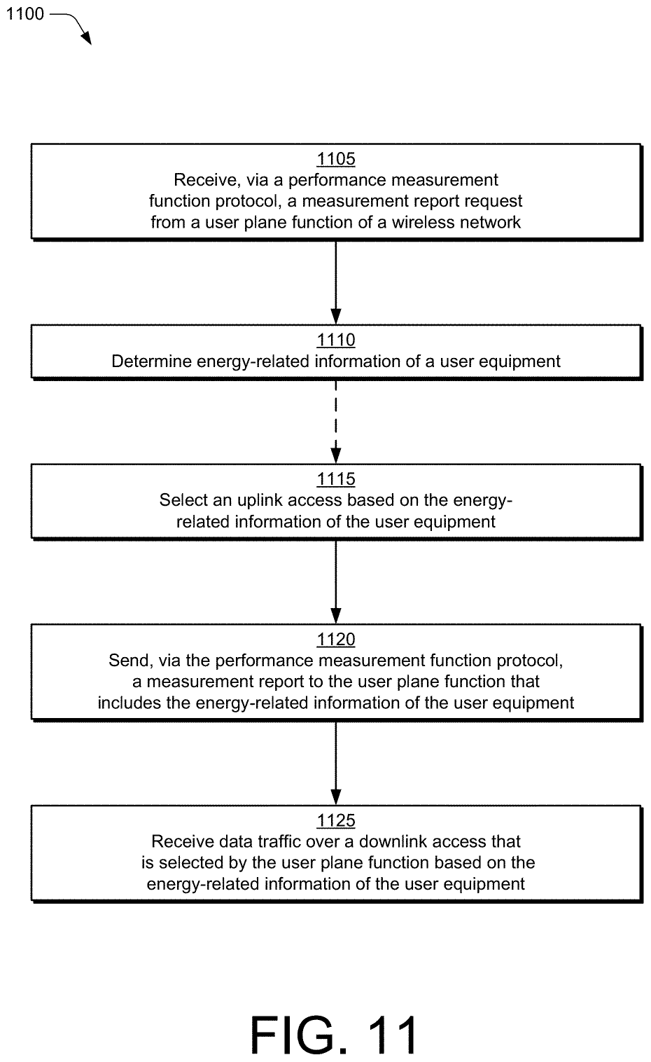

FIG. 7B illustrates at 720 example details of data and control transactions between devices switching an uplink access or switching a downlink access in accordance with energy-aware traffic management. Generally, the user equipment 110 can switch (e.g., handover) a data flow (e.g., SDF) from the cellular access 204 to the non-cellular access 180, or switch (e.g., handover) the data flow from the non-cellular access 180 to the cellular access 204. The data flow may have been previously established on an uplink access or downlink access selected in accordance with energy-aware traffic management as described with reference to FIG. 7A, FIG. 8A, FIG. 10, FIG. 11, or FIG. 12A, or other non-energy-aware traffic steering. The example is presented in the context of a measurement report procedure, though operations described in reference to FIG. 7B for switching an access may be initiated or performed by either of the user equipment 110 or the UPF 160 of the 5GC 140 independent of the measurement report procedure, such as described with reference to FIG. 8B, FIGS. 9-12A, FIG. 13, or FIG. 14.

At 722, the UPF 160 sends a measurement report request to the user equipment 110 via the PMF 240 of the UPF 160. The measurement report request includes parameters for measurement of energy-related information 406 of the user equipment 110, such as energy consumption levels for accesses (e.g., respective transmit power), a lowest-energy access (e.g., a preferred access), or thermal conditions at the user equipment. The UPF 160 can send the measurement report request to the user equipment 110 through the non-cellular access 180 via the N3IWF 210, through a trusted non-cellular access (not shown), or the cellular access 204 via the base station 120.

In response to the measurement report request, the user equipment 110 measures, at 724, energy-related parameters of the user equipment, such as local conditions 360. The user equipment 110 measures the energy-related parameters at 724 to provide energy-related information 406 of the user equipment. In some cases, the energy-aware traffic manager 370 of the user equipment 110 estimates a first level of energy consumed by a 5G NR transceiver 508 of the user equipment 110 to transfer data traffic at a particular data rate over a cellular access 204 and estimates a second level of energy consumed by a WLAN transceiver 516 of the user equipment 110 to transfer the data traffic at the particular data rate over a WLAN 320. The user equipment 110 may estimate or determine relative levels of energy consumed by the transceivers of the user equipment that are idle (e.g., maintaining a downlink) or actively receiving data from the cellular access 204 or the WLAN 320. Alternatively or in addition, the energy-aware traffic manager 370 may collect battery status 408 information of the user equipment 110, location information 414, thermal conditions 412 of one or more components of the user equipment 110.

Optionally at 726, the user equipment 110 switches an uplink, e.g., a mobile-originated data uplink, from one access to another access based on the energy-related information 406. In some aspects, the user equipment 110 implements operations 724 and 726 independent of the measurement report procedure to switch a data flow from a current uplink access to another uplink access to reduce user equipment energy consumption. The user equipment 110 can switch the uplink access in accordance with the energy-aware traffic management mode 404 or in response to measuring the energy-related parameters at 724. For example, the user equipment 110 may switch data traffic to an uplink access that consumes a lower amount of user equipment energy to transmit a particular amount of data to an access point 190 of the cellular access 204 or WLAN AP 190 of the WLAN 320. Note that in some circumstances, the user equipment 110 may switch to a higher-energy uplink access that offers a higher data rate (e.g., higher performance uplink), which in turn may reduce an amount of time used by the user equipment to transmit a given amount of data. In other words, quickly transmitting the given amount of data via the higher-energy uplink access can be more energy-efficient than transmitting the same amount of data over a lower-energy, lower-rate uplink access for a longer duration of time. Alternatively or in addition, the user equipment 110 may select an uplink for access switching based on the energy-related information 406 and data rate requirements estimated for applications of the user equipment (e.g., minimum required data rates), such as by using the data rate estimations described with reference to FIG. 7C, FIG. 8C, or FIG. 12B.

At 728, the user equipment 110 sends, via the PMF 240, a measurement report to the UPF 160 that includes the energy-related information 406 of the user equipment. The energy-aware traffic manager 370 of the user equipment 110 can send, via the energy-aware PMF protocol 454, the measurement report to the UPF 160 to indicate the respective levels of energy consumption (e.g., transmit power) associated with transferring the data traffic over the cellular access 204 and WLAN 320, respectively. Alternatively or in addition, the energy-aware traffic manager 370 can send a measurement report to the UPF 160 that indicates a preferred access for a downlink, a current uplink access (e.g., switched uplink access) for transferring data traffic, an unavailability of a non-preferred access, a lower-energy uplink access selected by the user equipment 110 (e.g., at 1215 of FIG. 12A), the battery status 408, or the thermal conditions 412 of the components of the user equipment 110. The user equipment 110 can send the measurement report to the UPF 160 through the non-cellular access 180 via the N3IWF 210, through a trusted non-cellular access (e.g., TNGF of a TNAN), or the cellular access 204 via the base station 120.

Using the energy-related information 406 of the measurement report, the UPF 160 switches, at 730, a downlink access for transferring data traffic of the user equipment 110. The UPF 160 can switch a current downlink access to another downlink access that reduces energy consumption at the user equipment (e.g., a preferred downlink access), such as by switching to a downlink access that corresponds with a lower-energy uplink access of the user equipment. For example, as described with reference to FIG. 7D or FIG. 8D, switching a data flow over to a reciprocal downlink in a same access as an uplink of the user equipment 110 (e.g., access merging) may enable the user equipment to place a transceiver of another access in a standby or low-power mode, thereby reducing energy consumption of the user equipment. Concluding the present example, the UPF 160 transfers, at 732, data traffic of the user equipment on the downlink access to which the user equipment is switched. With a switched uplink access or downlink access for a data flow, the user equipment may split the data flow in the access as described with reference to FIG. 7C, FIG. 8C, or FIG. 12B, or merge split accesses as described with reference to FIG. 7D or FIG. 8D to provide a single access for communicating with the wireless network.

FIG. 7C illustrates at 740 example details of data and control transactions between devices splitting data traffic in a downlink access in accordance with one or more aspects of energy-aware traffic management. Generally, the user equipment 110 can split a data flow (e.g., SDF) across the cellular access 204 and the non-cellular access 180. The data flow may have been previously established on or switched to an uplink access or downlink access in accordance with energy-aware traffic management as described with reference to FIG. 7A, FIG. 7B, FIG. 8A, FIG. 8B, FIG. 9 though FIG. 12A, FIG. 13, or FIG. 14, or other non-energy-aware traffic steering. The example is presented in the context of a measurement report procedure, though operations described in reference to FIG. 7C for splitting data traffic in an access may be initiated or performed by either of the user equipment 110 or the UPF 160 of the 5GC 140 independent of the measurement report procedure, such as described with reference to FIG. 8C or FIG. 12B.

The UPF 160 sends, at 742, a measurement report request to the user equipment 110 via the PMF 240 of the UPF 160. The measurement report request includes parameters for measurement of energy-related information 406 of the user equipment 110, such as energy consumption levels for accesses (e.g., respective transmit power), a lowest-energy access (e.g., a preferred access), or thermal conditions at the user equipment. The UPF 160 can send the measurement report request to the user equipment 110 through the non-cellular access 180 via the N3IWF 210, through a trusted non-cellular access (not shown), or the cellular access 204 via the base station 120.

In response to the measurement report request, the user equipment 110 measures, at 744, energy-related parameters of the user equipment, such as local conditions 360. The user equipment 110 measures the energy-related parameters at 744 to provide energy-related information 406 of the user equipment. In some cases, the energy-aware traffic manager 370 of the user equipment 110 estimates a first level of energy consumed by a 5G NR transceiver 508 of the user equipment 110 to transfer data traffic at a particular data rate over a cellular access 204 and estimates a second level of energy consumed by a WLAN transceiver 516 of the user equipment 110 to transfer the data traffic at the particular data rate over a WLAN 320. The user equipment 110 may estimate or determine relative levels of energy consumed by the transceivers of the user equipment that are idle (e.g., maintaining a downlink) or actively receiving data from the cellular access 204 or the WLAN 320. Alternatively or in addition, the energy-aware traffic manager 370 may collect battery status 408 information of the user equipment 110, location information 414, thermal conditions 412 of one or more components of the user equipment 110.

Optionally at 746, the user equipment 110 splits data traffic in an uplink, e.g., a mobile-originated data uplink, based on the energy-related information 406. In some aspects, the user equipment 110 implements operations 744 and 746 independent of the measurement report procedure to switch a data flow from a current uplink access to another uplink access. The user equipment 110 can split the data traffic into the uplink access in accordance with the energy-aware traffic management mode 404 or in response to measuring the energy-related parameters at 744. For example, the user equipment 110 may increase a ratio of data traffic that is split into an uplink access that consumes a lower amount of user equipment energy to transmit a particular amount of data to an access point 190 of the cellular access 204 or WLAN AP 190 of the WLAN 320.

In aspects, the user equipment 110 determines a ratio (e.g., optimal ratio) for splitting uplink traffic based on a required data rate for the uplink traffic, which may be different (non-symmetrical) from a required data rate for uplink traffic. In aspects, the ratio for splitting the uplink traffic splits at least a portion of the uplink traffic (e.g., a non-zero amount) in the cellular access and at least another portion of the uplink traffic (e.g., a non-zero amount) in the non-cellular access. The energy-aware traffic manager 370 may estimate a required data rate (e.g., traffic load) for uplink traffic of the user equipment 110 based on applications executing on the user equipment, including respective QoS parameters (e.g., required bit rates) for each application. In some cases, the energy-aware traffic manager 370 re-estimates the ratio for uplink splitting when a change in traffic load of the user equipment is detected, such as when an executing application ceases or another application begins executing, which may occur on the order of a few minutes. Additionally, when a data rate of a preferred uplink access (e.g., lower-energy access) is insufficient, the user equipment may alter the uplink split ratio or use another uplink access for a remainder of the required data rate. The estimated required data rates for uplink traffic of user equipment 110 applications may also be used for energy-aware traffic steering, switching, or merging as described herein.

Alternatively or in addition, the user equipment 110 may determine a ratio (e.g., optimal ratio) for splitting downlink traffic based on a required data rate for the downlink traffic, which may be different (non-symmetrical) from a required data rate for uplink traffic. In aspects, the ratio for splitting the downlink traffic splits at least a portion of the downlink traffic (e.g., a non-zero amount) in the cellular access and at least another portion of the downlink traffic (e.g., a non-zero amount) in the non-cellular access. The energy-aware traffic manager 370 can estimate a required data rate (e.g., traffic load) of the user equipment 110 for downlink traffic based on the applications executing on the user equipment, including respective QoS parameters (e.g., required bit rates) for each application. In some cases, the energy-aware traffic manager 370 re-estimates the ratio for downlink splitting when a change in traffic load of the user equipment is detected, such as when an executing application ceases or another application begins executing, which may occur on the order of a few minutes. Additionally, when a data rate of a preferred downlink access (e.g., a lower-energy access) is insufficient for traffic load of the user equipment, the user equipment may alter the downlink split ratio or use another downlink access for a remainder of the required data rate. The estimated required data rates for downlink traffic of user equipment 110 applications may also be used for energy-aware traffic steering, switching, or merging as described herein.

At 748, the user equipment 110 sends, via the PMF 240, a measurement report to the UPF 160 that includes the energy-related information 406 of the user equipment. The energy-aware traffic manager 370 of the user equipment 110 can send, via the energy-aware PMF protocol 454, the measurement report to the UPF 160 to indicate the respective levels of energy consumption associated with maintaining an active data link with or transferring the data traffic over the cellular access 204 and WLAN 320, respectively. Alternatively or in addition, the energy-aware traffic manager 370 can send a measurement report to the UPF 160 that indicates a preferred access for a downlink, a preferred ratio for splitting data traffic on a downlink access, a current ratio selected for splitting data traffic on an uplink access, an unavailability of a non-preferred access, a lower-energy uplink access to which the user equipment 110 is steering or switching data flows, the battery status 408, or the thermal conditions 412 of the components of the user equipment 110.

In aspects, the user equipment 110 may send, via the energy-aware PMF protocol 454, a ratio for splitting downlink traffic (e.g., determined at 746) to the UPF 160 effective to cause or direct the UPF 160 to split downlink traffic to the user equipment based on the determined ratio. In some cases, the UPF 160 updates downlink access scheduling based on the ratio determined by the user equipment to direct the downlink traffic over the cellular and non-cellular accesses at the ratio requested by the user equipment. In some aspects, the user equipment 110 sends, via the energy-aware PMF protocol 454, a ratio for splitting uplink traffic (e.g., determined at 746) to the UPF 160 effective to cause or direct the core network (e.g., PFC 270) to push new or updated ATSSS rules with the ratio determined by the user equipment. In some cases, the energy-aware rules 402 allow the user equipment 110 to use the determined uplink splitting ratio to split data traffic in the uplink access without receiving updated ATSSS rules. In other cases, the energy-aware traffic management mode 404 may enable the user equipment 110 to dynamically determine and use an optimal ratio for splitting data traffic in the uplink access without an update of the ATS SS rules 350.

Using the energy-related information 406 of the measurement report, the UPF 160 splits, at 750, data traffic of the user equipment 110 in a downlink access. The UPF 160 can split the data traffic in a downlink access that reduces energy consumption at the user equipment, such as by increasing a ratio of data traffic split in a downlink access that corresponds with a lower-energy uplink access of the user equipment. For example, splitting a data flow in a reciprocal downlink in a same access as an uplink of the user equipment 110 (e.g., access merging) may enable the user equipment use a transceiver of another access for less time, thereby reducing energy consumption of the user equipment. Concluding the present example, the UPF 160 transfers, at 752, the data traffic split in the downlink access to the user equipment. With data traffic split between respective uplink or downlink accesses, the user equipment may merge split accesses as described with reference to FIG. 7D or FIG. 8D to provide a single access for communicating with the wireless network.

FIG. 7D illustrates at 760 example details of data and control transactions between devices merging split accesses in accordance with one or more aspects of energy-aware traffic management. Generally, the user equipment 110 can merge an uplink access with a downlink access or UPF 160 can merge a downlink access with an uplink access based on energy-related information 406 of the user equipment. For example, an uplink of one access can be merged with a downlink of another access to provide a single merged access over which data traffic of the user equipment is routed. By doing so, the user equipment 110 may communicate, via a single transceiver, data traffic over the merged access and power down an unused transceiver of another access to reduce energy consumption of the user equipment.

Prior to merging accesses, the data traffic of the user equipment 110 may be steered to, switched to, or split in one of the uplink access or the downlink access in accordance with energy-aware traffic management as described with reference to FIG. 7A through FIG. 7C, FIG. 8A through FIG. 8C, FIG. 9 through FIG. 14, or other non-energy-aware traffic steering. The example is presented in the context of a measurement report procedure, though operations described in reference to FIG. 7D for merging an access may be initiated or performed by either of the user equipment 110 or the UPF 160 of the 5GC 140 independent of the measurement report procedure, such as described with reference to 8D. For example, the user equipment 110 may merge an uplink access or cause the UPF 160 to merge a downlink access based on energy-related information 406 in accordance with energy-aware rules 402, energy-aware traffic management mode 404, or energy-aware rules 456, such as described with reference to FIG. 4, FIG. 8D, FIG. 9, FIG. 13 or FIG. 14.

At 762, the UPF 160 sends a measurement report request to the user equipment 110 via the PMF 240 of the UPF 160. The measurement report request includes parameters for measurement of energy-related information 406 of the user equipment 110, such as energy consumption levels for accesses (e.g., respective transmit power), a lowest-energy access (e.g., a preferred access), or thermal conditions at the user equipment. The UPF 160 can send the measurement report request to the user equipment 110 through the non-cellular access 180 via the N3IWF 210, through a trusted non-cellular access (not shown), or the cellular access 204 via the base station 120.

In response to the measurement report request, the user equipment 110 measures, at 764, energy-related parameters of the user equipment, such as local conditions 360. The user equipment 110 measures the energy-related parameters at 764 to provide energy-related information 406 of the user equipment. In some cases, the energy-aware traffic manager 370 of the user equipment 110 estimates a first level of energy consumed by a 5G NR transceiver 508 of the user equipment 110 to transfer data traffic at a particular data rate over a cellular access 204 and estimates a second level of energy consumed by a WLAN transceiver 516 of the user equipment 110 to transfer the data traffic at the particular data rate over a WLAN 320. The user equipment 110 may estimate or determine relative levels of energy consumed by the transceivers of the user equipment that are idle (e.g., maintaining a downlink) or actively receiving data from the cellular access 204 or the WLAN 320. Alternatively or in addition, the energy-aware traffic manager 370 may collect battery status 408 information of the user equipment 110, location information 414, thermal conditions 412 of one or more components of the user equipment 110.

Optionally at 766, the user equipment 110 merges an uplink access, e.g., a mobile-originated data uplink, with a downlink access based on the energy-related information 406. In some aspects, the user equipment 110 implements operations 764 and 766 independent of the measurement report procedure to merge a current uplink access with another access that corresponds to a downlink access. The user equipment 110 can merge the uplink access with a downlink access in accordance with the energy-aware traffic management mode 404 or in response to measuring the energy-related parameters at 764. For example, the user equipment 110 can merge an access of the uplink an access of a downlink that consumes less user equipment energy to transfer a particular amount of data to an access point 190 of the cellular access 204 or WLAN AP 190 of the WLAN 320. The user equipment 110 may then power down a transceiver of the access from which the uplink is moved, reducing energy consumption of the user equipment. Note that in some circumstances, the user equipment 110 may merge the uplink to a higher-energy access that offers a higher data rate, which in turn may reduce an amount of time used by the user equipment to transmit a given amount of data. In other words, quickly transmitting the given amount of data via the higher-energy merged uplink access can be more energy-efficient than transmitting the same amount of data over a lower-energy, lower-rate uplink access for a longer duration of time. Alternatively or in addition, the user equipment 110 may determine to merge an uplink access (or downlink access) based on the energy-related information 406 and data rate requirements estimated for applications of the user equipment (e.g., minimum required data rates), such as by using the data rate estimations described with reference to FIG. 7C, FIG. 8C, or FIG. 12B.

At 768, the user equipment 110 sends, via the PMF 240, a measurement report to the UPF 160 that includes the energy-related information 406 of the user equipment. The energy-aware traffic manager 370 of the user equipment 110 can send, via the energy-aware PMF protocol 454, the measurement report to the UPF 160 to indicate the respective levels of energy consumption associated with maintaining an active data link with, or transferring the data traffic over, the cellular access 204 and WLAN 320, respectively. Alternatively or in addition, the energy-aware traffic manager 370 can send a measurement report to the UPF 160 that indicates a preferred access for a downlink, a preferred ratio for splitting data traffic on a downlink access, a current ratio selected for splitting data traffic on an uplink access, an unavailability of a non-preferred access, a lower-energy uplink access to which the user equipment 110 is steering or switching data flows, the battery status 408, or the thermal conditions 412 of the components of the user equipment 110.

Optionally at 770, the UPF 160 merges a downlink access using the energy-related information 406 of the measurement report. In some cases, the UPF 160 merges the downlink to an access that reduces energy consumption at the user equipment, such as by changing an access of the downlink to match an access that corresponds with a lower-energy uplink access of the user equipment. For example, moving a data flow to a reciprocal downlink in a same access as an uplink of the user equipment 110 may enable the user equipment use one transceiver to communicate with the access point 190 of the cellular access 204 or the WLAN AP 190 of the WLAN 320. The user equipment 110 can then power down or reduce use the transceiver of the other access, thereby reducing energy consumption of the user equipment. Concluding the present example, the UPF 160 transfers, at 772, the data traffic over a downlink of the merged access to user equipment. The UPF 160 may also receive data traffic over the merged access from the user equipment 110. With a single merged access, the user equipment may initiate other energy-aware traffic management operations to select another uplink access or downlink access over which to steer new data flows as described with reference to FIG. 7A, FIG. 8A, or FIGS. 9-12A.

FIG. 8A through FIG. 8D provide examples of access traffic steering, switching, splitting, and merging that may be performed in accordance with an energy-aware traffic management mode, such as the energy-aware traffic management mode 404 of FIG. 4. For example, the energy-aware traffic manager 370 of the user equipment 110 may implement access traffic steering, switching, splitting, or merging operations according to the energy-aware rules 402 or the energy-aware traffic management mode 404. The energy-aware rules 402 may enable the energy-aware traffic manager to override non-energy-aware rules or non-energy-aware traffic management modes to implement aspects of energy-aware traffic management. In some cases, the energy-aware rules 402 enable the user equipment 110 to determine respective ratios for splitting data traffic over uplink accesses and downlink accesses, which the user equipment is prevented from changing in non-energy-aware ATSSS steering modes. Alternatively or in addition, the energy-aware traffic management mode 404 can cause or direct the user equipment to steer, switch, split, or merge data traffic over the uplink accesses and downlink accesses based on energy-related information 406 to reduce energy consumption of the user equipment.

FIG. 8A illustrates at 800 example details of data and control transactions between devices steering data traffic over an uplink access or a downlink access in accordance with an energy-aware traffic management mode. The example of FIG. 8A may be implemented to select respective uplink and downlink accesses for steering new data flows initiated by the user equipment 110 in accordance with aspects of energy-aware traffic management. In some aspects, the user equipment 110 implements an energy-aware traffic management mode 404 in which an uplink access with lower energy consumption is selected for steering data flows (e.g., new SDFs) of the user equipment to the wireless network. Additionally, the energy-aware traffic management mode 404 may enable the user equipment 110 to select a downlink access to reduce user equipment energy consumption and direct (e.g., request) the UPF 160 to steer data flows over the downlink access selected by the user equipment. The operations shown in FIG. 8A may be implemented by the user equipment 110 or the UPF 160 as part of a measurement procedure as described with reference to FIG. 7A or other aspects of energy-aware traffic steering as described with reference to FIG. 10 through FIG. 12A.

In an example, the user equipment 110 selects, at 802, an uplink access for steering data flows using the energy-aware traffic management mode 404. Based on the energy-aware traffic management mode 404, the user equipment 110 may select the uplink access having a level of energy consumption that is lower than those of other available uplink accesses. To facilitate this selection, the energy-aware traffic manager 370 can estimate respective levels of energy consumption to communicate, at one or more data rates, data over a cellular access and a non-cellular access of the wireless network. The energy consumption to communicate the data over a respective access includes an amount of power consumed by a transmitter to transmit the data via a mobile-originated data uplink from the user equipment 110 to a receiving entity associated with the access, such as a base station 120 or WLAN AP 190. Alternatively or in addition, the user equipment 110 may select an uplink access that meets a minimum performance metric, which may include a minimum data rate, QoS level, or throughput for applications of the user equipment. In aspects, the uplink selection is based on the energy-related information 406 and data rate requirements estimated for applications of the user equipment (e.g., minimum required data rates), such as by using the data rate estimations described with reference to FIG. 7C, FIG. 8C, or FIG. 12B. After selecting the uplink access for data traffic steering, the user equipment 110 transfers, at 804, data traffic over the selected uplink access to the UPF 160. The data traffic transferred by the user equipment 110 may include a new data flow initiated by or for an application of the user equipment.

Using the energy-aware traffic management mode 404, the user equipment 110 may also select a downlink access for steering traffic from the UPF 160. To do so, the user equipment may determine which downlink access has a level of energy consumption that is lower than those of other available downlink accesses. In some cases, the user equipment 110 prefers a downlink access that corresponds to the selected uplink access. This may enable the user equipment 110 to transmit and receive data using a single transceiver type, which reduces energy consumption when communicating with the wireless network. Alternatively or in addition, the user equipment may select a downlink access that meets a minimum receive performance, such as a minimum data rate, QoS level, or throughput for applications of the user equipment. In aspects, the downlink selection is based on the energy-related information 406 and data rate requirements estimated for applications of the user equipment (e.g., minimum required data rates), such as by using the data rate estimations described with reference to FIG. 7C, FIG. 8C, or FIG. 12B. As such, the user may not select the downlink access that consumes the least amount of energy, but the lowest-energy downlink access that is able to support the minimum receive performance required by the applications of the user equipment.

At 806, the user equipment 110 sends, to the UPF 160, an indication of a preference for a downlink access. In some aspects, the user equipment 110 dynamically updates the UPF 160 with notifications, via the energy-aware PMF protocol 454, for which downlink access is preferred by the user equipment for traffic steering from a perspective of energy consumption. Based on the indication of the preference for the downlink access, the UPF 160 selects, at 808, a downlink access for steering data traffic that is transferred to the user equipment 110. The downlink access selected by the UPF 160 may correspond to the uplink access selected by the user equipment in accordance with the energy-aware rules 456 implemented by the UPF 160. Concluding the present example, the UPF 160 transfers, at 810, data traffic over the selected downlink access to the user equipment 110. The data traffic transferred by the UPF 160 over the selected downlink access may include a new data flow of traffic requested by or for an application of the user equipment. With an uplink access or downlink access selected for steering a data flow, the user equipment may switch an access of the data flow as described with reference to FIG. 7B, FIG. 8B, FIG. 9, FIG. 13, or FIG. 14, or split the data flow in the access as described with reference to FIG. 7C, FIG. 8C, or FIG. 12B. Alternatively or in addition, the user equipment can merge split accesses as described with reference to FIG. 7D or FIG. 8D to provide a single access for communicating with the wireless network.

FIG. 8B illustrates at 820 example details of data and control transactions between devices switching an uplink access or a downlink access in accordance with an energy-aware traffic management mode. The example of FIG. 8B may be implemented to switch (e.g., handover) a data flow of the user equipment to another uplink access or downlink access in accordance with aspects of energy-aware traffic management. The data flow may have been previously established on an uplink access or downlink access selected in accordance with energy-aware traffic management as described with reference to FIG. 7A, FIG. 8A, FIG. 10, FIG. 11, or FIG. 12A, or other non-energy-aware traffic steering. In some aspects, the user equipment 110 implements an energy-aware traffic management mode 404 in which a data flow of the user equipment is switched or handed over to an uplink access with lower energy consumption. Additionally, the energy-aware traffic management mode 404 may enable the user equipment 110 to select a downlink access with lower energy consumption and direct the UPF 160 to switch downlink traffic of the data flow over to the downlink access selected by the user equipment. One or more of the operations shown in FIG. 8B may be implemented by the user equipment 110 or the UPF 160 as part of a measurement procedure as described with reference to FIG. 7B or other aspects of energy-aware access switching as described with reference to FIG. 10 through FIG. 12A, FIG. 13, of FIG. 14.

In an example, the user equipment 110 switches, at 822, an uplink access for a data flow using the energy-aware traffic management mode 404. Based on the energy-aware traffic management mode 404, the user equipment 110 may switch to the uplink access having a level of energy consumption that is lower than those of other available uplink accesses. To facilitate this selection, the energy-aware traffic manager 370 can estimate respective levels of energy consumption to communicate, at one or more data rates, data over a cellular access and a non-cellular access of the wireless network. The energy consumption of the respective access includes an amount of power consumed by a transmitter to transmit, from the user equipment 110, the data via a mobile-originated data uplink to a receiving entity associated with the access, such as a base station 120 or WLAN AP 190. In aspects, the uplink selection is based on the energy-related information 406 and data rate requirements estimated for applications of the user equipment (e.g., minimum required data rates), such as by using the data rate estimations described with reference to FIG. 7C, FIG. 8C, or FIG. 12B. After switching the uplink access for data traffic, the user equipment 110 transfers, at 824, data traffic over the switched uplink access to the UPF 160. In other words, the user equipment 110 hands over uplink traffic of the data flow to the selected uplink access that may reduce power consumption of the user equipment.

Using the energy-aware traffic management mode 404, the user equipment 110 may also switch a downlink access for downlink traffic of the data flow. To do so, the user equipment may determine which downlink access has a level of energy consumption that is lower than those of other available downlink accesses. In some cases, the user equipment 110 prefers a downlink access that corresponds to the switched uplink access. This may enable the user equipment 110 to transmit and receive data using a single transceiver type, which can reduce energy consumption when communicating with the wireless network. Alternatively or in addition, the user equipment may switch to a downlink access that meets a minimum receive performance, such as a minimum data rate, QoS level, or throughput for applications of the user equipment. In aspects, the downlink selection is based on the energy-related information 406 and data rate requirements estimated for applications of the user equipment (e.g., minimum required data rates), such as by using the data rate estimations described with reference to FIG. 7C, FIG. 8C, or FIG. 12B. As such, the user may not switch to the downlink access that consumes the least amount of energy, but switch to the lowest-energy downlink access that is able to support the minimum receive performance required by the applications of the user equipment.

At 826, the user equipment 110 sends, to the UPF 160, an indication of a preference for a downlink access for traffic switching. In some aspects, the user equipment 110 dynamically updates the UPF 160 with notifications, via the energy-aware PMF protocol 454, for which downlink access is preferred by the user equipment for traffic switching from a perspective of energy consumption. Based on the indication of the preference for the downlink access, the UPF 160 switches, at 828, a downlink access for data traffic that is transferred to the user equipment 110. The switched downlink access of the UPF 160 may correspond to the switching uplink access of the user equipment 110 in accordance with the energy-aware rules 456 implemented by the UPF 160. Concluding the present example, the UPF 160 transfers, at 830, data traffic over the switched downlink access to the user equipment 110. With a switched uplink access or downlink access for a data flow, the user equipment may split the data flow in the access as described with reference to FIG. 7C, FIG. 8C, or FIG. 12B, or merge split accesses as described with reference to FIG. 7D or FIG. 8D to provide a single access for communicating with the wireless network.

FIG. 8C illustrates at 840 example details of data and control transactions between devices splitting data traffic in an uplink access or a downlink access in accordance with aspects of energy-aware traffic splitting. The example of FIG. 8C may be implemented to split a data flow of the user equipment in an uplink access or downlink access in accordance with aspects of energy-aware traffic management. The data flow may have been previously established on or switched to an uplink access or downlink access in accordance with energy-aware traffic management as described with reference to FIG. 7A, FIG. 7B, FIG. 8A, FIG. 8B, FIG. 9 though FIG. 12A, FIG. 13, or FIG. 14, or other non-energy-aware traffic steering. In some aspects, the user equipment 110 implements an energy-aware traffic management mode 404 in which the user equipment splits a data flow in an uplink access with lower energy consumption. Additionally, the energy-aware traffic management mode 404 may enable the user equipment 110 to determine a ratio for splitting traffic in a downlink access and direct the UPF 160 to split the data traffic in the downlink access based on the ratio provided by the user equipment. One or more of the operations shown in FIG. 8C may be implemented by the user equipment 110 or the UPF 160 as part of a measurement procedure as described with reference to FIG. 7C or other aspects of energy-aware traffic splitting as described with reference to FIG. 9 or 12B.

In an example, the user equipment 110 splits, at 842, data traffic in the uplink access using the energy-aware traffic management mode 404. The energy-aware traffic manager 370 can determine an optimal ratio by which to split traffic data in the uplink access based on at least energy consumption associated with the uplink access and a data rate of the uplink access. In some cases, the optimal ratio is configured to route a portion of the data traffic over an uplink access to meet a minimum latency or throughput requirement for a particular service data flow to which the portion of data traffic corresponds. The energy-aware traffic manager 370 can also determine an optimal ratio by which to split traffic data in the downlink access based on at least energy consumption associated with the downlink access and a data rate of the downlink access.

In aspects, the user equipment 110 determines a ratio (e.g., optimal ratio) for splitting uplink traffic based on a required data rate for the uplink traffic, which may be different (non-symmetrical) from a required data rate for uplink traffic. The energy-aware traffic manager 370 may estimate a required data rate (e.g., traffic load) for uplink traffic of the user equipment 110 based on applications executing on the user equipment, including respective QoS parameters (e.g., required bit rates) for each application. In some cases, the energy-aware traffic manager 370 re-estimates the ratio for uplink splitting when a change in traffic load of the user equipment is detected, such as when an executing application ceases or another application begins executing, which may occur on the order of a few minutes. Additionally, when a data rate of a preferred uplink access (e.g., lower-energy access) is insufficient, the user equipment may alter the uplink split ratio or use another uplink access for a remainder of the required data rate. The estimated required data rates for uplink traffic of user equipment 110 applications may also be used for energy-aware traffic steering, switching, or merging as described herein.

The user equipment 110 may also determine a ratio (e.g., optimal ratio) for splitting downlink traffic based on a required data rate for the downlink traffic, which may be different (non-symmetrical) from a required data rate for uplink traffic. The energy-aware traffic manager 370 can estimate a required data rate (e.g., traffic load) of the user equipment 110 for downlink traffic based on the applications executing on the user equipment, including respective QoS parameters (e.g., required bit rates) for each application. In some cases, the energy-aware traffic manager 370 re-estimates the ratio for downlink splitting when a change in traffic load of the user equipment is detected, such as when an executing application ceases or another application begins executing, which may occur on the order of a few minutes. Additionally, when a data rate of a preferred downlink access (e.g., a lower-energy access) is insufficient for traffic load of the user equipment, the user equipment may alter the downlink split ratio or use another downlink access for a remainder of the required data rate. The estimated required data rates for downlink traffic of user equipment 110 applications may also be used for energy-aware traffic steering, switching, or merging as described herein.

The user equipment 110 sends, at 844, data traffic that is split in the uplink access to the UPF 160 of the wireless network. The data traffic is split in the uplink access based on the determined ratio for splitting the uplink traffic and a remainder of the data traffic may be split in another uplink access for transfer to the UPF 160. At 846, the user equipment 110 sends, to the UPF 160, an indication of the ratio for traffic splitting in the downlink access. In some aspects, the user equipment 110 updates the UPF 160 with notifications, via the energy-aware PMF protocol 454, for downlink access splitting ratio that is preferred by the user equipment from a perspective of energy consumption. As described, the energy-aware traffic manager 370 can determine an optimal ratio by which to split traffic data in the downlink access based on at least energy consumption associated with receiving the downlink and a data rate of the downlink access.

In some aspects, the user equipment 110 sends, via the energy-aware PMF protocol 454, a ratio for splitting uplink traffic (e.g., determined at 746) to the UPF 160 effective to cause or direct the core network (e.g., PFC 270) to push new or updated ATSSS rules with the ratio determined by the user equipment. In some cases, the energy-aware rules 402 allow the user equipment 110 to use the determined uplink splitting ratio to split data traffic in the uplink access without receiving updated ATSSS rules 350. In other cases, the energy-aware traffic management mode 404 enables the user equipment 110 to dynamically determine and use an optimal ratio for splitting data traffic in the uplink access.

Based on the indication for the ratio for traffic splitting in the downlink access, the UPF 160 splits, at 848, data traffic of the user equipment 110 in a downlink access. The indication received from the user equipment 110 may cause or direct the UPF 160 to split downlink traffic to the user equipment based on the determined ratio. In some cases, the UPF 160 updates downlink access scheduling based on the ratio determined by the user equipment to direct the downlink traffic over the cellular and non-cellular accesses at the ratio requested by the user equipment. Splitting the data traffic in the downlink access may reduce energy consumption at the user equipment, such as by increasing a ratio of data traffic split in a downlink access that corresponds with a lower-energy uplink access of the user equipment. For example, splitting a data flow in a reciprocal downlink in a same access as an uplink of the user equipment 110 (e.g., access merging) may enable the user equipment use a transceiver of another access for less time, thereby reducing energy consumption of the user equipment. Concluding the present example, the UPF 160 transfers, at 850, the data traffic split in the downlink access to the user equipment. With data traffic split between respective uplink or downlink accesses, the user equipment may merge split accesses as described with reference to FIG. 7D or FIG. 8D to provide a single access for communicating with the wireless network.

FIG. 8D illustrates at 860 example details of data and control transactions between devices merging split accesses to provide a single access based on an energy-aware traffic management mode. The example of FIG. 8D may be implemented to merge an uplink access with a downlink access or merge a downlink access with an uplink access in accordance with aspects of energy-aware traffic management to provide a single access over which the user equipment 110 transfers a data flow (e.g., SDF). In some aspects, the user equipment 110 implements an energy-aware traffic management mode 404 in which an uplink of one access can be merged with a downlink of another access to provide a single merged access over which data traffic of the user equipment is routed. Additionally, the energy-aware traffic management mode 404 may enable the user equipment 110 to select a downlink access with lower energy consumption and direct (or request) the UPF 160 to merge the downlink with an active uplink access of user equipment to provide the single merged access. One or more of the operations shown in FIG. 8C may be implemented by the user equipment 110 or the UPF 160 as part of a measurement procedure as described with reference to FIG. 7D. Prior to merging accesses, the data traffic of the user equipment 110 may be steered to, switched to, or split in one of the uplink access or the downlink access in accordance with energy-aware traffic management as described with reference to FIGS. 7A through FIG. 8C, FIG. 9 though FIG. 14, or other non-energy-aware traffic steering.

Optionally at 862, the user equipment 110 merges an uplink access, e.g., a mobile-originated data uplink, with a downlink access using an energy-aware traffic management mode 404. Generally, the user equipment 110 merges the uplink access with the downlink access based on the energy-related information 406 of the user equipment. For example, the user equipment 110 can change an access of the uplink to match an access of a downlink that consumes a lower amount of user equipment energy to transmit a particular amount of data to an access point 190 of the cellular access 204 or WLAN AP 190 of the WLAN 320. The user equipment 110 may then power down a transceiver of the access from which the uplink is moved, reducing energy consumption of the user equipment.

Note that in some circumstances, the user equipment 110 may move the uplink to a higher-energy uplink access that offers a higher data rate, which in turn may reduce an amount of time used by the user equipment to transmit a given amount of data. In other words, quickly transmitting the given amount of data via the higher-energy uplink access can be more energy-efficient than transmitting the same amount of data over a lower-energy, lower-rate uplink access for a longer duration of time. Alternatively or in addition, the user equipment 110 may determine to merge an uplink access (or downlink access) based on the energy-related information 406 and data rate requirements of the user equipment applications (e.g., minimum required data rates), such as described with reference to FIG. 7C, FIG. 8C, or FIG. 12B.

At 864, the user equipment 110 sends, via the PMF 240 and to the UPF 160, an indication of the merged uplink access or a preferred downlink access to merge. The indication sent at 864 may also include energy-related information 406 of the user equipment, such as a measurement report to indicate the respective levels of energy consumption associated with maintaining an active data link with, or transferring the data traffic over, the cellular access 204 and WLAN 320, respectively. The indication sent by the user equipment 110 to the UPF 160 may cause or direct the UPF 160 to merge the split downlink access with an active uplink access of the user equipment.

Optionally at 866, the UPF 160 merges a downlink access based on the indication received from the user equipment 110. The UPF 160 may merge the downlink access based on an indication by the user equipment for a preferred downlink access, such as an information element in an energy-aware PMF protocol 454 message specifying a move of the downlink to an access the corresponds to an active uplink of the user equipment. In some cases, the UPF 160 merges the downlink to an access that reduces energy consumption at the user equipment, such as by changing an access of the downlink to match an access that corresponds with a lower-energy uplink access of the user equipment. For example, moving a data flow to a reciprocal downlink in a same access as an uplink of the user equipment 110 may enable the user equipment use one transceiver to communicate with the access point 190 of the cellular access 204 or the WLAN AP 190 of the WLAN 320. The user equipment 110 can then power down or reduce use the transceiver of the other access, thereby reducing energy consumption of the user equipment. Concluding the present example, the UPF 160 transfers, at 868, the data traffic over a downlink of the merged access to user equipment. The UPF 160 may also receive data traffic over the merged access from the user equipment 110. With a single merged access, the user equipment may initiate other energy-aware traffic management operations to select another uplink access or downlink access over which to steer new data flows as described with reference to FIG. 7A, FIG. 8A, or FIGS. 9-12A.

FIG. 9 illustrates at 900 example details of data and control transactions between devices for switching an uplink access or downlink access in response to a critical event or condition related to user equipment energy in accordance with one or more aspects. In aspects, non-energy-aware steering modes are improved by leveraging information relating to a battery level, thermal conditions, or other local conditions of the user equipment 110. To mitigate effects associated with the critical event, such as reduced user equipment functionality, the user equipment 110 switches or steers data traffic to a lower-energy access to reduce consumption of user equipment energy, which may extend user equipment runtime or decrease user equipment temperature. The user equipment 110 may also merge split accesses into a single access for uplink and downlink communication, enabling the user equipment to consolidate wireless communication to one transceiver for reduced energy consumption.

In an example, the user equipment 110 detects, at 905, a critical event relating to user equipment energy. The energy-aware traffic manager 370 can detect that a battery capacity of the user equipment 110 is below a critical battery threshold or detect that a temperature of a processor or transceiver of the user equipment 110 is above a critical temperature threshold. In response to detection of the critical event, the user equipment 110 switches, at 910, to an uplink access that has a level of energy consumption that is lower than a current uplink access of the user equipment. Alternatively, the user equipment 110 can select an uplink to steer data traffic over if the user equipment does not have an active data session established with the UPF 160. Prior to the selection, the energy-aware traffic manager 370 may consult traffic steering rules of the user equipment 110 to determine whether a currently selected steering mode (e.g., non-energy-aware steering mode) can be overridden to force selection of the lower-energy access. The selection of the lower-energy access reduces consumption of user equipment energy, which can mitigate effects of the critical event on operation of the user equipment.

At 915, the user equipment 110 sends, to the UPF 160, an indication of a preferred downlink access. By using a downlink access that corresponds to the selected uplink access, the user equipment 110 communicates with the wireless network using one transceiver. Thus, other transceivers of the user equipment 110 may be powered down or put in standby to further conserve energy of the user equipment. The user equipment 110 can also send, at 920, an indication of a type of the critical event to the UPF 160. In some cases, measurement reporting rules provided by the PCF 270 limit a type or frequency of energy-aware notifications sent by the user equipment 110 to manage (e.g., reduce) network overhead among multiple user equipment, which may number in the hundreds or thousands.

Based on the indication of the preferred downlink access, the UPF 160 switches, at 925, to a downlink access for the user equipment 110. For example, the UPF 160 may switch the downlink access to one that corresponds to the uplink access to which the user equipment switched. At 930, the user equipment 110 detects cessation or termination of the critical event relating to user equipment energy. The energy-aware traffic manager 370 can detect that the battery capacity of the user equipment 110 is above the critical battery threshold or detect that the temperature of the processor or transceiver of the user equipment 110 is below the critical temperature threshold. After cessation of the critical event, the user equipment 110 selects, at 935, another uplink access based on traffic rules of the user equipment, such as ATSSS rules 350 or energy-aware rules 402. Thus, the user equipment 110 may cease to override a previously active ATS SS steering mode. At 940 the user equipment 110 sends, to the UPF 160, an indication of the cessation of the critical event. In response to the notification of the cessation of the critical event, the UPF 160 selects, at 945, another downlink access based on the energy-aware traffic rules 402 or other ATSSS rules 350 of the UPF 160, such as to restore operation of the overridden steering mode. With a switched uplink access or downlink access for a data flow, the user equipment may split the data flow in the access as described with reference to FIG. 7C, FIG. 8C, or FIG. 12B, or merge split accesses as described with reference to FIG. 7D or FIG. 8D to provide a single access for communicating with the wireless network.

Example Methods for Energy-Aware Traffic Management

Example methods 1000-1400 are described with reference to FIGS. 10-14 in accordance with one or more aspects of energy-aware traffic management for multi-access data sessions. The order in which the method blocks are described are not intended to be construed as a limitation, and any number of the described method blocks can be skipped or combined in any order to implement a method or an alternative method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively, or additionally, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (AS SPs), System-on-a-chip systems (SoCs), Complex Programmable Logic Devices (CPLDs), and the like.

FIG. 10 illustrates example method 1000 of energy-aware traffic management as generally related to steering data traffic based on energy-related information provided by a user equipment 110. Alternatively, the operations of method 1000 may be implemented to switch a downlink access based on energy-related information provided by a user equipment. At block 1005, a user plane function (UPF) of a wireless network sends a measurement report request to a user equipment via a performance measurement function (PMF) protocol. For example, the UPF 160 sends a measurement report request to the user equipment 110 through the cellular access 204 or non-cellular access 180 via the PMF protocol 454.

At block 1010, the UPF receives, via the PMF protocol, a measurement report from the user equipment that includes energy-related information of the user equipment. For example, the UPF 160 receives, via the PMF protocol 454, a measurement report from the user equipment 110 that includes energy-related information 406, such as a low battery level or thermal condition of the user equipment 110. Alternatively or in addition, the energy-related information 406 includes an indication of a lower-energy access for the user equipment 110, a preferred downlink access for the user equipment, or a lower-energy uplink access selected by the user equipment 110 for steering data traffic.

At block 1015, the UPF selects a downlink access for the user equipment based on the energy-related information of the user equipment. For example, the UPF 160 selects a WLAN 330 as a lower-energy non-cellular downlink access for the user equipment 110 based on the energy-related information 406. The energy-related information 406 can indicate that a wireless link with the WLAN 330 consumes less energy than a wireless link with the RAN 130 and the low battery level of the user equipment 110. By so doing, the UPF 160 reduces an amount of energy consumed by the user equipment 110 to communicate with the wireless network, thereby extending a runtime of the user equipment 110. Alternatively, the UPF 160 can switch a downlink access for the user equipment based on an indicated preference for a downlink access or an indicated unavailability of a non-preferred access of the user equipment. At block 1020, the UPF transfers data traffic of the wireless network to the user equipment over the selected downlink access. Concluding the present example, the UPF 160 transfers data traffic to the user equipment 110 over the WLAN 330, which consumes less energy of the user equipment than a cellular access and extends the runtime of the user equipment. After selecting the downlink access for steering a data flow, the UPF 160 may switch the downlink access of the data flow as described with reference to FIG. 7B, FIG. 8B, FIG. 9, FIG. 13, or FIG. 14, or split the data flow in the downlink access as described with reference to FIG. 7C, FIG. 8C, or FIG. 12B.

FIG. 11 illustrates an example method 1100 of providing energy-related information of a user equipment to a user plane function of a wireless network to facilitate downlink access selection in accordance with one or more aspects. The user plane function of the wireless network can steer data traffic over or switch data traffic to the selected downlink access to route the data traffic to the user equipment. At block 1105, the user equipment receives, via a performance measurement function (PMF) protocol, a measurement report request from a user plane function (UPF) of a wireless network.

At block 1110, the user equipment determines energy-related information of the user equipment. For example, an energy-aware traffic manager 370 of the user equipment 110 determines a first level of energy consumed by a 5G NR transceiver 508 of the user equipment 110 to transfer data traffic at a particular data rate over a cellular access 204 and determines a second level of energy consumed by a WLAN transceiver 516 of the user equipment 110 to transfer the data traffic at the particular data rate over a WLAN 320. Alternatively or in addition, the energy-aware traffic manager 370 may collect battery status information of the user equipment 110 or thermal conditions of one or more components of the user equipment 110.

Optionally at block 1115, the user equipment selects an uplink access for traffic steering or traffic switching based on the energy-related information of the user equipment. In aspects, the user equipment 110 selects an uplink access, e.g., a mobile-originated data uplink, for steering a data flow based on the energy-related information 406. For example, the user equipment 110 may select the uplink access that consumes a lower amount of user equipment energy to transmit a particular amount of data to an access point 190 of the cellular access 204 or WLAN AP 190 of the WLAN 320. Note that in some circumstances, the user equipment 110 may select a higher-energy uplink access that offers a higher data rate (e.g., higher performing uplink), which in turn may reduce an amount of time used by the user equipment to transmit a given amount of data. In other words, quickly transmitting the given amount of data via the higher-energy uplink access can be more energy-efficient than transmitting the same amount of data over a lower-energy, lower-rate uplink access for a longer duration of time.

At block 1120, the user equipment sends, via the PMF protocol, a measurement report to the UPF that includes the energy-related information of the user equipment. For example, the energy-aware traffic manager 370 sends, via the PMF protocol 454, a measurement report to the UPF 160 that includes the first and second levels of energy consumption associated with transferring the data traffic over the cellular access 204 and WLAN 320, respectively. Alternatively or in addition, the energy-aware traffic manager 370 can send, via the PMF protocol 454, a measurement report to the UPF 160 that indicates the battery status or thermal conditions of the components of the user equipment 110. In some aspects, the measurement report is effective to direct or request that the UPF 160 selects or switches to a downlink access for the user equipment 110 based on the energy-related information, such as to reduce energy consumption by the user equipment 110.

At block 1125, the user equipment receives data traffic over a downlink access that is selected by the UPF based on the energy-related information of the user equipment. For example, the user equipment 110 receives data traffic over a downlink of the cellular access 204, which the UPF 160 selects or steer to as a lower-energy access (e.g., due to proximity) for serving data traffic to the user equipment 110. After selecting the uplink access or downlink access for steering a data flow, the user equipment may switch an access of the data flow as described with reference to FIG. 7B, FIG. 8B, FIG. 9, FIG. 13, or FIG. 14, or split the data flow in the access as described with reference to FIG. 7C, FIG. 8C, or FIG. 12B.

FIG. 12A illustrates an example method 1200 of energy-aware traffic management as generally related to selecting an uplink access based on respective energy consumption of cellular and non-cellular accesses of a wireless network. The operations of method 1200 may be implemented by a user equipment 110 to select or switch to an uplink access over which data traffic is transferred to a user plane function 160 of a wireless network. At block 1205, a user equipment estimates a first level of energy consumption for a first uplink access. For example, an energy-aware traffic manager 370 of the user equipment 110 determines or estimates a first level of energy consumption (e.g., first transmit power) for transferring data traffic via an uplink of the cellular access 204.

At block 1210, the user equipment estimates a second level of energy consumption for a second uplink access. For example, the energy-aware traffic manager 370 of the user equipment 110 determines or estimates a second level of energy consumption (e.g., second transmit power) for transferring data traffic via an uplink of the WLAN 320. At block 1215, the user equipment selects, based on the first and second levels of energy, one of the first uplink access or the second uplink access as an uplink access. In some cases, the access having the lower level of energy consumption is selected as the uplink access. For example, the energy-aware traffic manager 370 of the user equipment 110 selects the uplink of the WLAN 320 as the lower-energy uplink to transfer data traffic to the wireless network.

At block 1220, the user equipment indicates, to the wireless network, a preference for a downlink access that corresponds to the selected uplink access. This may be effective to enable the user equipment to request or direct the wireless network to select the downlink access that corresponds to the selected uplink access. In some aspects, the user equipment 110 dynamically updates the UPF 160 with notifications, via the energy-aware PMF protocol 454, for which downlink access is preferred by the user equipment for traffic steering from a perspective of energy consumption. The selected uplink access of the user equipment may include the uplink access that has the lower level of energy consumption. For example, the energy-aware traffic manager 370 sends, via the PMF protocol 454, a message to the UPF 160 indicating that the WLAN 320 is the preferred low-energy access of the user equipment 110. This may be effective to cause the user plane function of the wireless network to steer or switch to downlink access that corresponds to the preferred uplink access of the user equipment, which may include the lower-energy access.

At block 1225, the user equipment communicates data with the wireless network over the selected uplink access and the corresponding downlink access. For example, the user equipment 110 transmits data to the wireless network via the uplink of the WLAN 320 and receives other data from the wireless network via the downlink of the WLAN 320. Because the WLAN 320 is selected based on having the lower level of energy consumption, the communication of the data through the WLAN 320 consumes less energy of the user equipment than using the cellular access 204, and may extend a runtime of the user equipment 110. After selecting the uplink access or downlink access for steering a data flow, the user equipment may switch an access of the data flow as described with reference to FIG. 7B, FIG. 8B, FIG. 9, FIG. 13, or FIG. 14, or split the data flow in the access as described with reference to FIG. 7C, FIG. 8C, or FIG. 12B.

FIG. 12B illustrates an example method 1250 of energy-aware traffic management as generally related to splitting data traffic in an uplink access based on respective energy consumption of cellular and non-cellular accesses of a wireless network. The operations of method 1250 may be implemented by a user equipment 110 to split data traffic communicated with a user plane function of a wireless network in an uplink access and/or downlink access based on energy parameters of the user equipment (e.g., energy-related information 406). The data traffic may have been previously established on or switched to an uplink access or downlink access in accordance with energy-aware traffic management as described with reference to FIG. 7A, FIG. 7B, FIG. 8A, FIG. 8B, FIG. 9 though FIG. 12A, FIG. 13, or FIG. 14, or other non-energy-aware traffic steering. At block 1255, a user equipment estimates a first level of energy consumption for a first uplink access. For example, an energy-aware traffic manager 370 of the user equipment 110 determines or estimates a first level of energy consumption (e.g., first transmit power) for transferring data traffic via an uplink of the cellular access 204.

At block 1260, the user equipment estimates a second level of energy consumption for a second uplink access. For example, the energy-aware traffic manager 370 of the user equipment 110 determines or estimates a second level of energy consumption (e.g., second transmit power) for transferring data traffic via an uplink of the WLAN 320. At block 1265 the user equipment determines a first ratio for splitting data traffic in the first uplink access and the second uplink access based on the first and second levels of energy consumption. For example, the energy-aware traffic manager 370 may determine a ratio of a first bandwidth in the WLAN 320 and a second bandwidth in the cellular access 204 by which to split data traffic between respective uplinks of the WLAN 320 and the cellular access 204.

In some cases, the energy-aware traffic manager 370 determines the ratio based on respective levels of power consumption for each uplink access, respective data rates of each uplink access, and quality of service requirements for the data traffic. In aspects, the user equipment 110 determines a ratio (e.g., optimal ratio) for splitting uplink traffic based on a required data rate for the uplink traffic, which may be different (non-symmetrical) from a required data rate for uplink traffic. The energy-aware traffic manager 370 may estimate a required data rate (e.g., traffic load) for uplink traffic of the user equipment 110 based on applications executing on the user equipment, including respective QoS parameters (e.g., required bit rates) for each application. In some cases, the energy-aware traffic manager 370 re-estimates the ratio for uplink splitting when a change in traffic load of the user equipment is detected, such as when an executing application ceases or another application begins executing, which may occur on the order of a few minutes.

At block 1270, the user equipment informs the wireless network of the first ratio for splitting the data traffic in the first uplink access and the second uplink access. For example, the energy-aware traffic manager 370 of the user equipment 110 sends, via the PMF protocol 454, a message to the UPF 160 indicating a preferred ratio for splitting data traffic between respective uplinks of the WLAN 320 and cellular access 204. At block 1275, the user equipment splits data traffic transferred to the wireless network in the first uplink access and the second uplink access based on the first ratio. For example, the user equipment 110 splits data traffic transferred to the UPF 160 in the uplinks of the WLAN 320 and the cellular access 204.

At block 1280 the user equipment determines a second ratio for splitting data traffic in downlink accesses of the wireless network. For example, the energy-aware traffic manager 370 may determine a ratio of a first bandwidth in the WLAN 320 and a second bandwidth in the cellular access 204 for splitting data traffic between respective downlinks of the WLAN 320 and the cellular access 204. In some cases, the energy-aware traffic manager 370 determines the ratio based on respective levels of power consumption for each downlink access, respective data rates of each downlink access, data rates required by applications of the user equipment, or quality of service requirements for the data traffic. For example, the user equipment can suggest the splitting ratio for downlink access based on a required data rate. In aspects, the user equipment 110 determines a ratio (e.g., optimal ratio) for splitting downlink traffic based on a required data rate for the downlink traffic, which may be different (non-symmetrical) from a required data rate for uplink traffic. The energy-aware traffic manager 370 may estimate a required data rate (e.g., traffic load) of the user equipment 110 for downlink traffic based on applications executing on the user equipment, including respective QoS parameters (e.g., required bit rates) for each application. In some cases, the energy-aware traffic manager 370 re-estimates the ratio for downlink splitting when a change in traffic load of the user equipment is detected, such as when an executing application ceases or another application begins executing, which may occur on the order of a few minutes. Generally, the user equipment may prefer to user the lower-energy downlink access as much as possible. When the data rate of a given downlink access becomes insufficient, the user equipment may determine to alter the splitting ratio for the downlink accesses to use the other downlink access to transfer a remainder of the required data rate.

At block 1285, the user equipment requests that the wireless network split the data traffic in the downlink accesses using the second ratio. For example, the energy-aware traffic manager 370 of the user equipment 110 sends, via the PMF protocol 454, a message to the UPF 160 indicating a requested ratio for splitting data traffic between respective downlinks of the WLAN 320 and cellular access 204. In some cases, the user equipment informs the UPF 160 of the wireless network of both the first ratio for splitting uplink data traffic and the second ratio for splitting downlink data traffic. The wireless network may then use the first and second ratios provided by the user equipment to push updated ATSSS rules that include new splitting ratios for uplink and downlink data traffic and a revised downlink data rate for down link scheduling. At block 1290, the user equipment receives data from the wireless network that is split in the downlink accesses using the second ratio. For example, the user equipment 110 receives data traffic from the user plane function of the wireless network that is split in the downlink of the WLAN 320 and the downlink of the cellular access 204 based on the second ratio provided to the user plane function by the user equipment 110.

In some aspects, the user equipment may be triggered to determine (or re-determine) one or both of the respective ratios for splitting traffic in the uplink access or the downlink access. For example, the user equipment 110 may re-determine an uplink or downlink traffic splitting ratio in response to detecting a change in traffic load of user equipment applications, a change in energy consumption associated with an access (in downlink or uplink), a change in a data rate available through an access (in uplink or downlink), or a critical event related to user equipment energy as described with reference to FIG. 13 or FIG. 14. To determine, calculate, or re-determine a traffic splitting ratio for an uplink or downlink access, the user equipment may perform the operations or acts described with reference to FIG. 7C, FIG. 8C, and/or FIG. 12B. Alternatively or in addition, the traffic splitting operations may be combined with the operations or acts described with reference to FIG. 13 or FIG. 14, which may be useful to implement adjustment of a traffic splitting ratio (e.g., energy-aware dynamic traffic splitting) in response to and after cessation of critical events related to user equipment energy.

FIG. 13 illustrates an example method 1300 switching an uplink access in response to a critical event related to user equipment energy in accordance with aspects of the techniques described herein. The data traffic may have been previously established on or switched to an uplink access or downlink access in accordance with energy-aware traffic management as described with reference to FIG. 7A, FIG. 7B, FIG. 8A, FIG. 8B, FIG. 9 though FIG. 12A, FIG. 13, or FIG. 14, or other non-energy-aware traffic steering. At block 1305, the user equipment detects a critical event related to energy of the user equipment. For example, the energy-aware traffic manager 370 of the user equipment 110 may detect that a battery capacity of the user equipment 110 is below a predefined threshold that specifies a low battery level.

At block 1310, the user equipment switches to or selects an uplink access in response to detection of the critical event. For example, the energy-aware traffic manager 370 of the user equipment 110 switches to an uplink of a WLAN 320 of a wireless network in response to detecting that the battery capacity of the user equipment 110 is below the predefined threshold. At block 1315, the user equipment indicates, to the wireless network, a preference for a downlink access that corresponds to the uplink access to which the user equipment switched. For example, the energy-aware traffic manager 370 sends a message to the UPF 160 that indicates a preference for a downlink of the WLAN 320 that corresponds to the uplink of the WLAN 320 to which the user equipment switched.

At block 1320, the user equipment indicates, to the wireless network, the detection or type of the critical event related to the energy of the user equipment. For example, the energy-aware traffic manager 370 sends a message to the UPF 160 that indicates the user equipment 110 has a critically low battery level, which may cause the user equipment 110 to override a provisioned steering mode to reduce energy consumption.

At block 1325, the user equipment detects cessation of the critical event related to energy of the user equipment. For example, the energy-aware traffic manager 370 may detect that the battery capacity is above the predefined threshold that specifies a low battery level. At block 1330, the user equipment switches to a previous uplink access in response to detecting cessation of the critical event. For example, the energy-aware traffic manager 370 switches back to or selects an uplink of the cellular access 204 based on a previously active steering mode. At block 1335, the user equipment indicates the cessation of the critical event to the wireless network. For example, the energy-aware traffic manager 370 sends, via the PMF protocol 454, a message to the UPF 160 that indicates the user equipment is no longer impaired by the critically low battery level. After cessation of the critical event, the user equipment 110 may steer, switch, split, or merge data traffic over one of the uplink access or the downlink access in accordance with the aspects of energy-aware traffic management as described with reference to FIGS. 7A through FIG. 12B, and FIG. 14.

FIG. 14 illustrates an example method 1400 of energy-aware traffic management as generally related to overriding an active steering mode of a user equipment in accordance with aspects of the techniques described herein. The data traffic may have been previously established on or switched to an uplink access or downlink access in accordance with energy-aware traffic management as described with reference to FIG. 7A, FIG. 7B, FIG. 8A, FIG. 8B, FIG. 9 though FIG. 12A, FIG. 13, or FIG. 14, or other non-energy-aware traffic management.

At block 1405, the user equipment detects a critical event related to energy of the user equipment. For example, the energy-aware traffic manager 370 of the user equipment 110 may detect that a temperature of the user equipment 110 exceeds an overheating threshold.

Optionally, at block 1410 the user equipment determines whether an active steering mode of the user equipment can be overridden. For example, the energy-aware traffic manager 370 of the user equipment 110 queries ATSSS rules 350 to determine if an active steering mode of the user equipment 110 permits overriding in response to detection of the critical event.

At block 1415, the user equipment switches, in response to detection of the critical event, to a lower-energy access uplink to communicate with a wireless network effective to override the active steering mode. For example, the energy-aware traffic manager 370 switches to or selects an uplink of the cellular access 204 that consumes less energy than an uplink of a WLAN 320 due to proximity of the user equipment 110 with a base station 120 of the cellular access 204. Optionally, at block 1420 the user equipment notifies the wireless network of the switch to the lower-energy uplink access. For example, the energy-aware traffic manager 370 sends, via the PMF protocol 454, a notification to the UPF 160 that the user equipment 110 switched to the cellular access 204 for the uplink with the wireless network.

At block 1425, the user equipment detects cessation of the critical event related to energy of the user equipment. For example, the energy-aware traffic manager 370 detects that the temperature of the user equipment 110 is below the overheating threshold. At block 1430, the user equipment returns to the previous active steering mode to switch or select an uplink access for traffic steering. For example, the energy-aware traffic manager 370 returns to a steering mode provisioned by the wireless network and switches back to an uplink access in accordance with the provisioned steering mode. Optionally, at block 1435 the user equipment notifies the wireless network of the return to the previous active steering mode. For example, the energy-aware traffic manager 370 sends, via the PMF protocol, a notification to the UPF 160 that the user equipment 110 has returned to a previously active steering mode. After cessation of the critical event, the user equipment 110 may steer, switch, split, or merge data traffic over one of the uplink access or the downlink access in accordance with the aspects of energy-aware traffic management as described with reference to FIGS. 7A through FIG. 13.

Although aspects of energy-aware traffic management for multi-access data sessions have been described in language specific to features and/or methods, the subject of the appended claims is not necessarily limited to the specific features or methods described. Rather, the specific features and methods are disclosed as example implementations of energy-aware traffic management of user equipment data between cellular and non-cellular accesses and other equivalent features and methods are intended to be within the scope of the appended claims. Thus, the appended claims include a list of features that can be selected in “any combination thereof,” which includes combining any number and any combination of the listed features. Further, various different aspects are described, and it is to be appreciated that each described aspect can be implemented independently or in connection with one or more other described aspects.

In the following, several examples of energy-aware traffic management for multi-access data sessions are described.

Example 1. A method of managing data traffic of a user equipment between a cellular access and anon-cellular access of a wireless network, the method comprising: estimating, by the user equipment, a first level of energy consumption associated with an uplink of the cellular access provided via a base station of the wireless network, the cellular access anchored by a user plane function, UPF, of the wireless network; estimating, by the user equipment, a second level of energy consumption associated with an uplink of the non-cellular access provided by a wireless local area network, WLAN, access point of the wireless network, the non-cellular access anchored by the UPF of the wireless network; selecting, based on the first level of energy consumption and the second level of energy consumption, the uplink of the cellular access or the uplink of the non-cellular access as an uplink access for transferring the data traffic of the user equipment to the wireless network; and transferring the data traffic of the user equipment via the selected uplink access to the UPF.

Example 2. The method as recited in example 1, wherein transferring the data traffic via the selected uplink access comprises any one or more of: switching the data traffic of the user equipment to the selected uplink access; steering the data traffic of the user equipment to the selected uplink access; or splitting at least a portion of the data traffic in the selected uplink access.

Example 3. The method as recited in example 1 or example 2, further comprising: determining a ratio by which to split the data traffic of the user equipment in the selected uplink access; and transferring, in accordance with the determined ratio, a portion of the data traffic of the user equipment to the UPF of the wireless network using the selected uplink access.

Example 4. The method as recited in example 3, wherein the determining the ratio by which to split the data traffic in the selected uplink access comprises determining the ratio based on the first level of energy consumption and the second level of energy consumption.

Example 5. The method as recited in example 3, further comprising obtaining first performance information associated with the uplink of the cellular access; obtaining second performance information associated with the uplink of the non-cellular access; and wherein the determining the ratio by which to split the data traffic in the selected uplink access further comprises determining the ratio based on the first performance information and the second performance information.

Example 6. The method as recited in example 5, wherein the first performance information comprises a data rate, a quality of service level, or a throughput of the uplink of the cellular service and the second performance information comprises a data rate, a quality of service level, or a throughput of the uplink of the non-cellular service.

Example 7. The method as recited in any of examples 1 to 6, further comprising sending an indication of the selected uplink access to the UPF of the wireless network effective to request the wireless network to select, as a selected downlink access, a downlink of an access that corresponds to the access of the selected uplink access.

Example 8. The method as recited in any of examples 1 to 7, further comprising: determining a ratio by which to split the data traffic of the user equipment in the selected downlink access; and sending an indication of the ratio to the UPF of the wireless network effective to request the wireless network to transfer, in accordance with the ratio, a portion of the data traffic of the user equipment using the selected downlink access.

Example 9. The method as recited in example 7 or example 8, wherein the indication of the selected uplink access or the indication of the ratio by which to split the data traffic in the selected downlink is sent to the UPF of the wireless network using a performance measurement function, PMF, protocol that includes a field or information element configured to indicate a ratio for splitting downlink traffic.

Example 10. The method as recited in example 8, wherein the determining the ratio by which to split the data traffic in the selected downlink access comprises determining the ratio based on the first level of energy consumption and the second level of energy consumption.

Example 11. The method as recited in examples 8 to 10, further comprising obtaining first performance information associated with the downlink of the cellular access; obtaining second performance information associated with the downlink of the non-cellular access; and wherein the determining the ratio by which to split the data traffic in the selected downlink access further comprises determining the ratio based on the first performance information and the second performance information.

Example 12. The method as recited in example 11, wherein the first performance information comprises a data rate, a quality of service level, or a throughput of the downlink of the cellular service and the second performance information comprises a data rate, a quality of service level, or a throughput of the downlink of the non-cellular service.

Example 13. The method as recited in any of the preceding examples, wherein the access having a lower level of energy consumption is selected as the uplink access for transferring the data traffic of the user equipment to the wireless network.

Example 14. The method as recited in any of the preceding examples, further comprising: detecting a critical event of the user equipment that includes one of a low battery level or overheating of at least one component of the user equipment; and wherein selecting the uplink of the cellular access or the uplink of the non-cellular access as the uplink access is performed in response to detecting the critical event of the user equipment.

Example 15. The method as recited in example 14, further comprising: configuring a field or information element of a PMF protocol message to indicate at least one of the critical event of the user equipment, an indication of a preferred downlink access, or a type of critical event of the user equipment; and sending, via the PMF protocol, the message to the UPF of the wireless network, the message being effective to notify the wireless network of at least one of the critical event of the user equipment, the preferred downlink access, or the type of the critical event of the user equipment.

Example 16. The method as recited in example 14 or example 15, further comprising: detecting cessation of the critical event related to the user equipment energy; and sending, using a PMF protocol and to the wireless network, an indication of the cessation of the critical event at the user equipment.

Example 17. The method as recited in any of the preceding examples, wherein: prior to the act of selecting, the user equipment is configured with an active traffic steering mode to manage the data traffic of the user equipment based on non-energy-based parameters; and the act of selecting the uplink access is effective to override the active traffic steering mode of the user equipment.

Example 18. The method as recited in any of the preceding examples, wherein the method is performed in accordance with an energy-aware traffic management mode implemented by the user equipment.

Example 19. A method of managing data traffic of a user equipment between a cellular access and a non-cellular access of a wireless network, the method comprising: detecting, at the user equipment, a critical event related to user equipment energy; in response to detecting the critical event, estimating respective levels of energy consumption for the user equipment to transmit, via an uplink of the cellular access and an uplink of the non-cellular access, the data traffic to the wireless network, the cellular access and the non-cellular access anchored by a user plane function, UPF, of the wireless network; selecting, based on the respective levels of energy consumption, the uplink of the cellular access or the uplink of the non-cellular access as an uplink access to transfer the data traffic to the wireless network; and transferring the data traffic of the user equipment via the selected uplink access to the UPF of the wireless network.

Example 20. The method as recited in example 19, wherein transferring the data traffic via the selected uplink access comprises any one or more of: switching the data traffic of the user equipment to the selected uplink access; steering the data traffic of the user equipment to the selected uplink access; or splitting at least a portion of the data traffic over the selected uplink access.

Example 21. The method as recited in example 19, wherein detecting the critical event related to the user equipment energy includes: detecting that a capacity of a battery of the user equipment is below a predefined capacity threshold; or detecting that a temperature of one or more components of the user equipment is above a respective temperature threshold.

Example 22. The method as recited in any of examples 19 to 21, further comprising at least one of: sending, using a performance measurement function, PMF, protocol and to the wireless network, an indication of a preferred access for a downlink that corresponds to the access of the selected uplink access; sending, using the PMF protocol and to the wireless network, an indication that the critical event occurred at the user equipment; or sending, using the PMF protocol and to the wireless network, an indication of a type of the critical event that occurred at the user equipment.

Example 23. The method as recited in any of examples 19 to 22, further comprising selecting the uplink of the cellular access or the uplink of the non-cellular access as the uplink access based on a data rate associated with the data traffic or a throughput associated with the data traffic.

Example 24. The method as recited in any of examples 19 to 23, further comprising: detecting cessation of the critical event related to the user equipment energy; and sending, using the PMF protocol and to the wireless network, an indication of the cessation of the critical event at the user equipment; or selecting, as the uplink access, the uplink of the cellular access or the uplink of the non-cellular uplink in accordance with an active energy-aware traffic management mode or an active traffic steering mode of the user equipment.

Example 25. A method of selecting between a cellular-access and a non-cellular access of a wireless network for a downlink to a user equipment, the method comprising: sending, by a user plane function, UPF, of the wireless network, a measurement report request to the user equipment using a performance measurement function, PMF, protocol; receiving, by the UPF and using the PMF protocol, a measurement report from the user equipment that includes respective energy-related information for the cellular access and/or the non-cellular access; selecting, by the UPF and based on the respective energy-related information, one of a downlink of the cellular access or a downlink of the non-cellular access as a selected downlink access for transferring data traffic to the user equipment; and transferring, by the UPF, the data traffic via the selected downlink access to the user equipment.

Example 26. The method as recited in example 25, wherein transferring the data traffic via the selected downlink access comprises: switching the data traffic of the user equipment to the selected downlink access; and/or steering the data traffic of the user equipment to the selected downlink access.

Example 27. The method as recited in example 25 or example 26, wherein: the respective energy-related information for the cellular access or the non-cellular access includes an indication by the user equipment of a preferred access for a downlink in an access based on energy of the user equipment; or the indication by the user equipment of the preferred access for the downlink further indicates an access selected by the user equipment for an uplink with the wireless network.

Example 28. The method as recited in any of examples 25 to 27, wherein: the respective energy-related information for the cellular access includes an indication of a first level of energy consumption associated with the user equipment communicating via the cellular access; and/or the respective energy-related information for the non-cellular access includes an indication of a second level of energy consumption associated with the user equipment communicating via the non-cellular access.

Example 29. A user equipment comprising: at least one wireless transceiver; a processor; and computer-readable storage media comprising instructions, responsive to execution by the processor, for directing the user equipment to perform any one of the methods recited in examples 1 to 24 using the at least one wireless transceiver.

Example 30. A core network server comprising: at least one wireless transceiver; a processor; and computer-readable storage media comprising instructions, responsive to execution by the processor, for directing the core network server to perform any one of the methods recited in examples 25 to 28 using the at least one wireless transceiver.

Example 31. A computer-readable storage media comprising instructions that, responsive to execution by a processor, cause a method as recited in any one of examples 1 to 28 to be performed.

1. A method of managing, by a user equipment, UE, data traffic using a cellular access and a non-cellular access of the UE to a wireless network, the method comprising:
estimating a first level of energy consumption associated with a first uplink using the cellular access provided via the wireless network to a wireless network device that hosts a user plane function, UPF, of the wireless network;
estimating a second level of energy consumption associated with a second uplink using the non-cellular access provided via a wireless local area network, WLAN, to the wireless network device that hosts the UPF;
determining, based on the first level of energy consumption and the second level of energy consumption, a ratio by which to split an uplink portion of the data traffic between the first uplink and the second uplink; and
transferring, in accordance with the ratio, the uplink portion of the data traffic from the UE via the first uplink and the second uplink to the wireless network device that hosts the UPF.

2. The method as recited in claim 1, further comprising:
sending an indication of the ratio to the wireless network device that hosts the UPF, the indication enabling the wireless network to transfer, in accordance with the ratio, a downlink portion of the data traffic of the UE using a first downlink via the cellular access and a second downlink via the non-cellular access to the UE.

3. The method as recited in claim 1, further comprising:
generating a performance measurement function, PMF, protocol message that includes a field or an information element configured to indicate the ratio; and
sending the PMF protocol message that indicates the ratio to the wireless network device that hosts the UPF.

4. (canceled)

5. The method as recited in claim 1, further comprising:
detecting a critical event that includes a low battery level or overheating of a component of the UE; and wherein:
the determining of the ratio is performed in response to the detecting of the critical event.

6. The method as recited in claim 5, further comprising:
generating a PMF protocol message to indicate the critical event or a type of the critical event; and
sending the PMF protocol message to the wireless network device that hosts the UPF.

7. The method as recited in claim 6, wherein the PMF protocol message is a first PMF protocol message and the method further comprises:
detecting a cessation of the critical event; and
sending a second PMF protocol message to the wireless network to indicate the cessation of the critical event.

8. The method as recited in claim 7, further comprising:
reselecting, in response to the cessation of the critical event, the first uplink or the second uplink as an uplink access for the uplink portion of data traffic of the UE.

9. (canceled)

10. (canceled)

11. The method as recited in claim 1, further comprising:
configuring the UE to implement an active traffic steering mode to manage the data traffic of the UE based on non-energy-based parameters; and
wherein the determining of the ratio by the user equipment is effective to override the active traffic steering mode of the UE.

12. A method of managing, by a wireless network device that hosts a user plane function, UPF, data traffic using a cellular-access and a non-cellular access of a user equipment, UE, to a wireless network, the method comprising:
receiving a performance measurement function, PMF, protocol message including a ratio for splitting a downlink portion of the data traffic to the UE between the cellular access and the non-cellular access;
modifying, a downlink access scheduling of a first downlink via the cellular access and a second downlink via the non-cellular access to the UE according to the ratio; and
transferring the downlink portion of the data traffic to the UE according to the downlink access scheduling.

13. The method as recited in claim 12, further comprising:
sending a measurement report request to the UE using another PMF protocol message, the measurement report request requesting first energy-related information for a first uplink data transfer from the UE to the wireless network device that hosts the UPF via the cellular access and second energy-related information for a second uplink transfer from the UE to the wireless network device that hosts the UPF via the non-cellular access.

14. (canceled)

15. The method as recited in claim 13, wherein:
the first energy-related information includes an indication of a first level of energy consumption associated with the first uplink data transfer; and
the second energy-related information includes an indication of a second level of energy consumption associated with the second uplink data transfer.

16. (canceled)

17. The method as recited in claim 12, further comprising:
receiving, from the UE, an uplink portion of the data traffic split between a first uplink via the cellular access and a second uplink via the non-cellular access in a ratio that corresponds to the ratio for splitting the downlink portion of the data traffic.

18. The method as recited in claim 12, wherein the measurement report includes an indication of an energy-related critical event of the UE or an indication of a type of the energy-related critical event of the UE.

19. The method as recited in claim 18, wherein the PMF protocol message is a first PMF protocol message and the method further comprises:
receiving a second PMF protocol message from the UE, the second PMF protocol message indicating a cessation of the energy-related critical event;
merging the first downlink and second downlink of the data traffic to one of the cellular access or non-cellular access; and
transferring the downlink portion of the data to the UE over one of the cellular access or the non-cellular access.

20. A user equipment, UE, comprising:
a first wireless transceiver configured to enable communication via a cellular access provided by a wireless network to a wireless network device that hosts a user plane function, UPF, of the wireless network;
a second wireless transceiver configured to enable communication via a non-cellular access provided by a wireless local area network, WLAN, to the wireless network device that hosts the UPF;
a traffic manager configured to:
estimate a first level of energy consumption associated with a first uplink using the cellular access provided via the wireless network;
estimate a second level of energy consumption associated with a second uplink using the non-cellular access provided via the WLAN;
determine, based on the first level of energy consumption and the second level of energy consumption, a ratio by which to split an uplink portion of data traffic between the first uplink and the second uplink; and
transfer, in accordance with the ratio, the uplink portion of the data traffic from the UE via the first uplink and the second uplink to the wireless network device that hosts the UPF.

21. The UE as recited in claim 20, wherein the traffic manager of the UE is further configured to:
send an indication of the ratio to the wireless network device that hosts the UPF, the indication enabling the wireless network to transfer, in accordance with the ratio, a downlink portion of the data traffic of the UE using a first downlink via the cellular access and a second downlink of the non-cellular access to the UE.

22. The UE as recited in claim 20, wherein the traffic manager of the UE is further configured to:
generate a performance measurement function, PMF, protocol message that includes a field or an information element configured to indicate the ratio; and
sending the PMF protocol message that indicates the ratio to the wireless network device that hosts the UPF.

23. The UE as recited in claim 20, wherein the traffic manager of the UE is further configured to:
detect a critical event that includes a low battery level or overheating of a component of the UE; and wherein:
the determining of the ratio is performed by the traffic manager in response to the detecting of the critical event.

24. The UE as recited in claim 23, wherein the traffic manager of the UE is further configured to:
generate a PMF protocol message to indicate the critical event or a type of the critical event; and
send the PMF protocol message to the wireless network device that hosts the UPF.

25. The UE as recited in claim 24, wherein the PMF protocol message is a first PMF protocol message and the traffic manager is further configured to:
detect a cessation of the critical event; and
send a second PMF protocol message to the wireless network device that hosts the UPF to indicate the cessation of the critical event.
